(19) United States
(12) Patent Application Publication
(10) Pub. No.: US 2026/0056704 A1
(43) Pub. Date: Feb. 26, 2026

(54) DISPLAY APPARATUS

(71) Applicant: VIDAA (NETHERLANDS) INTERNATIONAL HOLDINGS B.V., Duiven (NL)

(72) Inventors: Lin FAN, Qingdao (CN); Xin SHEN, Qingdao (CN); Song WU, Qingdao (CN)

(21) Appl. No.: 19/375,414

(22) Filed: Oct. 31, 2025

Related U.S. Application Data
(63) Continuation of application No. PCT/EP2024/079522, filed on Oct. 18, 2024.

(30) Foreign Application Priority Data
Oct. 19, 2023 (CN) 202311355290.7
Nov. 17, 2023 (CN) 202311544362.2
Jun. 17, 2024 (CN) 202410780628.1

(51) Int. Cl. G06F 3/16; G06F 3/0482

(52) U.S. Cl. CPC G06F 3/167; G06F 3/0482

(57) ABSTRACT

A display apparatus and a method for a voice service, and the method incudes: obtaining an iteration array, based on that the iteration array is in a non-empty state, controlling a display to display a function link entry for the voice service in a preset format; determining a target change menu control according to function change information in the iteration array; adding a preset identifier at a preset position of the target change menu control, and controlling the display to display a menu page in the preset format according to the preset identifier.

### CROSS-REFERENCE TO RELATED APPLICATIONS

This application is a continuation application of International Application No. PCT/EP2024/079522, filed on Oct. 18, 2024, which claims priorities to Chinese Patent Application No. 202410780628.1, filed on Jun. 17, 2024; Chinese Patent Application No. 202311544362.2, filed on Nov. 17, 2023; and Chinese Patent Application No. 202311355290.7, filed on Oct. 19, 2023, all of which are hereby incorporated by reference in their entireties.

### TECHNICAL FIELD

The present disclosure relates to the field of display apparatus, and particularly to a display apparatus.

### BACKGROUND

In order to facilitate a user to search for media resources, a display apparatus can be configured with voice service functions such as a voice assistant. As an auxiliary function of the display apparatus, the voice assistant can be configured to collect a voice command from the user, and can respond to the collected voice command, to enable the display apparatus to perform an action that matches an intention contained in the voice command from the user. Taking a voice service of a television as the display apparatus as the voice assistant as an example, after the voice assistant of the television obtains a voice command from the user, the voice command can be parsed through a semantic understanding model inside the television to obtain an analysis result. The analysis result contains the intention of the user, and then the analysis result containing the intention of the user is sent to the television. The television can perform a corresponding operation according to the analysis result for the voice command.

The voice assistant can support multiple languages, and the user can choose an appropriate language to interact according to his/her language habit. When there is a new language, the voice assistant can update a language list in the display apparatus by means of cloud configuration. Although the above method can realize a requirement of language update and the function of the voice assistant, there can still be some problems in the application of the voice assistant. Firstly, the language list requirements to be obtained from the cloud, and when the network is not good, there will be a failure to obtain the language list. In this case, the television can use a locally stored language by default, which can affect accuracy and timeliness of language settings. Secondly, refresh of the language list only occurs when the television is powered on or enters a page of a voice menu, and the user can only see when the language list is updated by entering the voice menu. Because the user generally does not view the voice menu frequently, when a new language is added to a television system through the cloud, the user cannot intuitively perceive language addition or update.

Therefore, during the use of the voice service in the display apparatus, in terms of language update and function representation, due to the lack of an effective function update prompt mechanism, the user cannot know the change of the language or function of the voice service, which affects the user's experience.

### SUMMARY

A display apparatus according to embodiments of the present disclosure can include: a display, configured to display an image and/or a user interface; a communicating device, configured to establish a communication connection with a server; at least one processor, in connection with the display and the communicating device, and configured to execute computer instructions to cause the display apparatus to: obtain an iteration array used for representing function change information of a menu control in a menu page of a voice service; based on that the iteration array is in a non-empty state, control the display to display a function link entry for the voice service in a preset format, where the function link entry is used for accessing a menu page of the voice service; the preset format is a format other than a format displayed in the menu page before a function of the menu control is changed; determine a target change menu control according to the function change information in the iteration array; add a preset identifier at a preset position of the target change menu control, where the preset identifier is used for indicating existence of change information of the target change menu control; and control the display to display the menu page in the preset format according to the preset identifier.

A method for a voice service in a display apparatus according to embodiments of the present disclosure can include: obtaining an iteration array used for representing function change information of a menu control in a menu page of the voice service; based on that the iteration array is in a non-empty state, controlling a display in the display apparatus to display a function link entry for the voice service in a preset format, where the function link entry is used for accessing a menu page of the voice service; the preset format is a format other than a format displayed in the menu page before the function of the menu control is changed; determining a target change menu control according to the function change information in the iteration array; adding a preset identifier at a preset position of the target change menu control, where the preset identifier is used for indicating existence of change information of the target change menu control; and controlling the display to display the menu page in the preset format according to the preset identifier.

### BRIEF DESCRIPTION OF FIGURES

FIG. 1 is a schematic diagram of an operation scenario between a display apparatus and a control device according to embodiments of the present disclosure;

FIG. 2 is a schematic diagram of a hardware configuration of a display apparatus according to embodiments of the present disclosure;

FIG. 3 is a schematic diagram of a software configuration of a display apparatus according to embodiments of the present disclosure;

FIG. 4 is a schematic diagram of a scenario in which a user views media resource data through a display apparatus according to embodiments of the present disclosure;

FIG. 5 is a flowchart of a method for a display apparatus to perform a voice service prompt according to embodiments of the present disclosure;

FIG. 6 is a schematic diagram of a function link entry for a display apparatus to access a voice service according to embodiments of the present disclosure;

FIG. 7 is a schematic diagram of a scenario in which a menu control is included in a voice service according to embodiments of the present disclosure;

FIG. 8 is a schematic diagram of an effect of providing a prompt page by a display apparatus according to embodiments of the present disclosure;

FIG. 9 is a schematic diagram of an effect of a voice interaction page according to embodiments of the present disclosure;

FIG. 10 is a schematic diagram of a scenario in which a display apparatus displays a function link entry for a voice service in a preset format according to embodiments of the present disclosure;

FIG. 11 is a schematic diagram of a scenario in which a menu control is added to a display apparatus according to embodiments of the present disclosure;

FIG. 12 is a schematic diagram of a scenario of viewing all function modules according to embodiments of the present disclosure;

FIG. 13 is a schematic diagram of a scenario of updating a sub-menu control according to embodiments of the present disclosure;

FIG. 14 is a flowchart of a display apparatus displaying a voice command learning page according to embodiments of the present disclosure;

FIG. 15 is a schematic diagram of a front page according to embodiments of the present disclosure;

FIG. 16 is a schematic diagram of a voice command learning page according to embodiments of the present disclosure;

FIG. 17 is a flowchart of a display apparatus displaying a voice command learning page according to embodiments of the present disclosure;

FIG. 18 is a flowchart of a display apparatus obtaining command information according to embodiments of the present disclosure;

FIG. 19 is a schematic diagram of a voice command learning page according to embodiments of the present disclosure;

FIG. 20 is a flowchart of a display apparatus responding to a first command based on a first option from a user according to embodiments of the present disclosure;

FIG. 21 is a flowchart of a display apparatus responding to a first command sent from a user through voice according to embodiments of the present disclosure;

FIG. 22 is a schematic diagram of a front page according to embodiments of the present disclosure;

FIG. 23 is a flowchart of a display apparatus displaying a history page according to embodiments of the present disclosure;

FIG. 24 is a schematic diagram of a history page according to embodiments of the present disclosure;

FIG. 25 is a flowchart of a display apparatus responding to a second command based on a third option from a user according to embodiments of the present disclosure;

FIG. 26 is an application scenario diagram of a display apparatus according to embodiments of the present disclosure;

FIG. 27 is another application scenario diagram of a display apparatus according to embodiments of the present disclosure;

FIG. 28 is a flowchart of a method for prompting an on/off state of a physical switch according to embodiments of the present disclosure;

FIG. 29 is a diagram of a setting interface for a control switch of an indicator light according to embodiments of the present disclosure;

FIG. 30 is a schematic diagram of a user interface according to embodiments of the present disclosure;

FIG. 31 is another schematic diagram of a user interface according to embodiments of the present disclosure;

FIG. 32 is a signaling diagram of an implementation of displaying a first prompt message according to embodiments of the present disclosure;

FIG. 33 is a flowchart of displaying different prompt messages according to embodiments of the present disclosure;

FIG. 34 is a signaling diagram of an implementation of displaying a second reminding message according to embodiments of the present disclosure;

FIG. 35 is a signaling diagram of an implementation of controlling an indicator light to be turned off according to embodiments of the present disclosure;

FIG. 36 is a flowchart of controlling an indicator light to perform different operations according to embodiments of the present disclosure;

FIG. 37 is a signaling diagram of an implementation of controlling an indicator light to be turned on according to embodiments of the present disclosure;

FIG. 38 is a flowchart of interaction logic of on/off state update of a control switch of an indicator light according to embodiments of the present disclosure.

### DETAILED DESCRIPTION

Embodiments will be described in detail, and examples are illustrated in accompanying drawings. When the following description refers to drawings, the same reference number in different drawings indicates same or similar elements, unless otherwise indicated. Embodiments described in the following embodiments are not intended to represent all embodiments consistent with the present disclosure. On the contrary, the embodiments are merely examples of systems and methods consistent with some aspects of the present disclosure as detailed in the appended claims.

It should be noted that the brief explanation for terms in the present disclosure is merely configured to understanding the embodiments better, but not for intending to limit embodiments of the present disclosure. Unless otherwise defined, the terms used in the present disclosure shall have the ordinary meaning as understood by those of ordinary skilled in the art.

The words “first”, “second”, “third” and the like used in the description, claims and drawings of the present disclosure do not represent any sequence, quantity or importance, but are only configured to distinguish similar or same kind of objects or entities. Unless otherwise defined, it should be noted that these words can be exchanged in an appropriate case.

Similar words such as “including”, “comprising” and any variants thereof used in the present disclosure mean that an element or item preceding the word covers elements or items listed behind the word and their equivalents without excluding other elements or items. For an example, a product or a device including a series of components does not need to be limited to explicitly list all of components, but can have other components which are not explicitly listed or which are essential to the product or the device.

The word “module” represents any known or developed hardware, software, firmware, artificial intelligence, fuzzy logic, or a combination of hardware and/or software codes, and is able to implement functions related to corresponding elements.

According to embodiments of the present disclosure, the display apparatus 200 generally refers to a device capable of displaying images and processing data. For example, the display apparatus 200 includes, but is not limited to, a smart television, a mobile terminal, a computer, a monitor, an advertising screen, a wearable device, and a virtual reality device, an augmented reality device, etc.

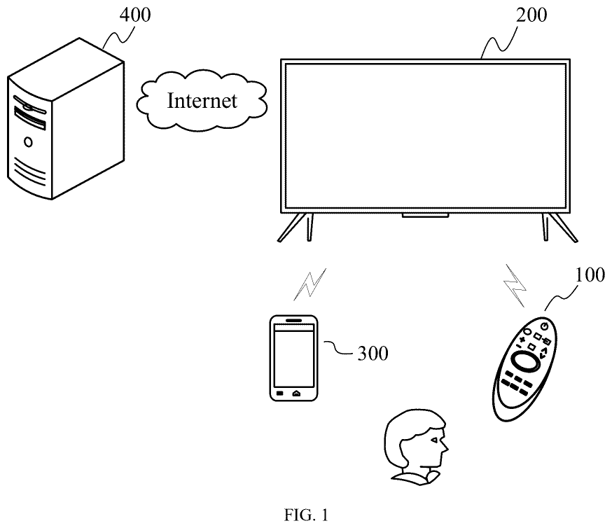

FIG. 1 is a schematic diagram of an operation scenario between a display apparatus and a control device according to embodiments of the present disclosure. As shown in FIG. 1, a user can operate the mobile terminal 300 by touch and operate the display apparatus 200 by the control device 100. The control device 100 is configured to receive an operation command input from a user, and convert the operation command into a control command that the display apparatus 200 can recognize and respond to. For example, the control device 100 can be a remote controller, a stylus, a joystick, or the like.

The mobile terminal 300 can serve as a control device for performing human-computer interaction between a user and the display apparatus 200. The mobile terminal 300 can also serve as a communicating device, and is configured to establish communication connection with the display apparatus 200 to perform data interaction. In some embodiments, the mobile terminal 300 and the display apparatus 200 can install a software application, and implement connection communication through a network communication protocol, to realize the purpose of one-to-one control operation and data communication. Audio and video content displayed on the mobile terminal 300 can also be transmitted to the display apparatus 200 to implement a synchronous display function.

In some embodiments, the mobile terminal 300 or another electronic device, can also simulate a function of the control device 100 by executing an application program that controls the display apparatus 200.

As further shown in FIG. 1, the display apparatus 200 also performs data communication with a server 400 through various communication methods. The display apparatus 200 can be allowed to perform communicative connection through a Local Area Network (LAN), a Wireless Local Area Network (WLAN), and other networks.

The display apparatus 200 can provide a broadcast reception television function, and can additionally provide a smart network television function supported by a computer, including but not limited to a network television, a smart television, an Internet Protocol television (IPTV), etc.

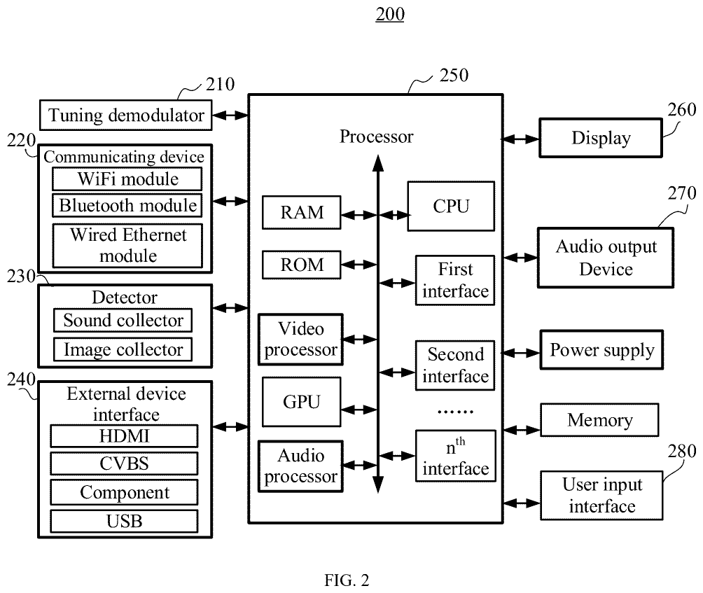

FIG. 2 is a block diagram of a hardware configuration of a display apparatus 200 in FIG. 1 according to embodiments of the present disclosure.

In some embodiments, the display apparatus 200 can include at least one of a tuning demodulator 210, a communicating device 220, a detector 230, a device interface 240, a processor 250, a display 260, an audio output device 270, a memory, a power supply, or a user input interface.

In some embodiments, the detector 230 is configured to collect a signal from external environment or external interaction. For example, the detector 230 includes an optical receiver and a sensor for collecting ambient light intensity; or, the detector 230 includes an image collector, such as a camera, which can be configured to collect an external environment scenario, a user attribute, or a user interaction gesture, or the detector 230 includes a sound collector, such as a microphone, which is configured to receive external sound.

In some embodiments, the display 260 includes a panel component for displaying an image, and a driver component for driving image display. The display 260 is configured to receive an image signal output from the processor 250 for display. For example, the display 260 can be configured to display video content, image content, a menu manipulation interface, and a UI for user operation, etc.

In some embodiments, the communicating device 220 is a component for communicating with an external device or the server 400 according to various communication protocol types. The display apparatus 200 can be provided with a plurality of communicating devices 220 according to supported different communication methods. For example, when the display apparatus 200 supports wireless network communication, the display apparatus 200 can be provided with a communicating device 220 including a WiFi function. When the display apparatus 200 supports Bluetooth connection communication, the display apparatus 200 can be provided with a communicating device 220 including a Bluetooth function.

The communication means 220 can communicatively connect the display apparatus 200 to an external device or the server 400 by wireless or wired connection. The wired connection can connect the display apparatus 200 with the external device through a data line, an interface, or the like. The wireless connection can connect the display apparatus 200 with the external device through a wireless signal or a wireless network. The display apparatus 200 can directly establish a connection relationship with the external device, and the connection relationship can also be established indirectly through a gateway, a router, a connection device, etc.

In some embodiments, the processor 250 can include a Central Processing Unit (CPU), a video processor, an audio processor, a Graphics Processing Unit (GPU), a power processor, a Random Access Memory (RAM), a Read-Only Memory (ROM), and a first interface to an n^{th} interface for input/output. The processor 250 controls operations of the display apparatus and responds to the user's operations through various software control programs stored in the memory. The processor 250 controls the overall operation of the display apparatus 200.

In some embodiments, the processor 250 and the tuning demodulator 210 can be in different independent devices, that is, the tuning demodulator 210 can be in an external device of a primary device in which the processor 250 is located, such as an external set-top box and etc.

In some embodiments, a user can input a user command on a Graphical User Interface (GUI) displayed on the display 260, then the user input interface receives an input command from the user through the GUI.

In some embodiments, the audio output device 270 can be an internal speaker of the display apparatus 200, and can also be an audio output device externally connected with the display apparatus 200. For the audio output device externally connected with the display apparatus 200, the display apparatus 200 can also be provided with an external audio output terminal. The audio output device can be connected with the display apparatus 200 through the external audio output terminal to output sounds of the display apparatus 200.

In some embodiments, the user input interface 280 can be configured to receive a command input from a user.

To perform interaction with the user, in some embodiments, the display apparatus 200 can run an operating system. The operate system is a computer program for managing and controlling hardware resources and software resources in the display apparatus 200. The operate system can control a user interface provide by the display apparatus, for example, the operating system can directly control the display apparatus to provide the user interface, or can provide the user interface by running an application program. The operating system can also allow a user to interact with the display apparatus 200.

It should be noted that the operating system can be a native operating system based on a specific operating platform, can also be a third-party operating system that is deeply customized based on a specific operating platform, and can also be an independent operating system specially developed for the display apparatus.

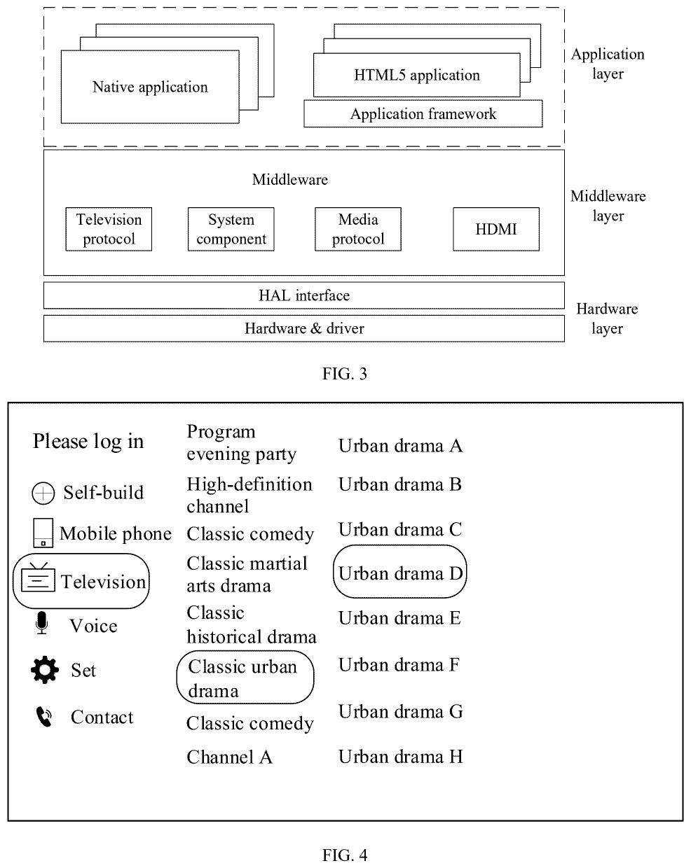

The operating system can be divided into different modules or levels depending on functions to be implemented. For example, as shown in FIG. 3, in some embodiments, the system is divided into three layers, which are an Applications layer (referred to as “application layer”), a middleware layer and a hardware layer from top to bottom.

In some embodiments, the application layer is configured to provide services and interfaces for applications, so that the display apparatus 200 can run applications and interact with a user based on the applications. At least one application is run in the application layer. The applications can be Window applications built in the operating system, system setting applications or clock applications and etc., and can be also applications developed by a third party. In some embodiments, applications in the application layer include but not limit to aforementioned examples.

A framework layer provides an Application Programming Interface (API) and a programming framework for the applications. An application framework layer includes some predefined functions. The application framework layer corresponds to a processing center which decides actions of applications in the application layer. The applications can access resources of the system and obtain services from the system through the API.

As shown in FIG. 3, FIG. 3 is a schematic diagram of a software configuration of a display apparatus in FIG. 1 according to embodiments of the present disclosure. The system of the display apparatus 200 can be divided into three layers, which are the application layer, the middleware layer, and the hardware layer from top to bottom.

The application layer mainly includes common applications on the television and an Application Framework. The common applications are mainly applications developed based on Browser, such as an HTML5 application and a native application.

The application Framework is a complete program model with all basic functions required by standard application software, such as file access, data exchange, etc., and a use interface of these functions (toolbar, status bar, menu, dialog box).

The native application can support online or offline, message push or local resource access.

The middleware layer includes middleware such as various television protocols, multimedia protocols, and system components. The middleware can use basic services (functions) provided by the system software, and link up various parts of the application system or different applications on the network, to achieve the purpose of resource sharing and function sharing.

The hardware layer mainly includes a Hardware Abstraction Layer (HAL) interface, hardware and drivers. The HAL interface is a unified interface for all television chips, and the specific logic is implemented by each of the chips. The drivers mainly include: an audio driver, a display driver, a Bluetooth driver, a camera driver, a WIFI driver, a USB driver, an HDMI driver, a sensor driver (such as a fingerprint sensor, a temperature sensor, a pressure sensor, etc.), and a power supply driver.

It should be noted that the above example is only a simple division of functions of the operating system, and does not limit the specific form of the operating system of the display apparatus 200 according to embodiments of the present disclosure. Depending on factors such as functions of the display apparatus and a type of operating system, etc., the number of levels and specific level types included in the operating system can take other forms.

The above embodiments illustrate hardware/software architecture and functional implementations of a display apparatus 200. Based on the display apparatus 200, not only media resource data such as audio and video can be viewed, but also a page can be set by setting relevant parameters of the page at the same time. FIG. 4 is a schematic diagram of a scenario in which a user views media resource data through a display apparatus according to embodiments of the present disclosure. As shown in FIG. 4, when the user wants to watch media resource data, for example, when the user wants to watch a certain movie, a media resource application is required to be opened first, then a media resource list can be found from a program list, such as a program evening party, a high-definition channel, a classic comedy, a classic urban drama, etc. After clicking a target program in the media resource list, media resource data to be watched is found from the target program. For example, when the user wants to view an urban drama D, the user requirements to select “television, classic urban drama, urban drama D” in turn. Media resource data requirements to be screened layer by layer to find the media resource data to be watched, and the steps are cumbersome.

In order to facilitate the user's operation and save the user's layer-by-layer screening steps, in some embodiments, the display apparatus 200 can be configured with a function of a voice service such as a voice assistant. As an auxiliary function of the display apparatus 200, the voice assistant can be configured to collect a voice command of the user, and respond to the collected voice command, so that the display apparatus 200 can perform an action matching an intention contained in the voice command of the user.

For example, when the display apparatus 200 is a television, after the voice assistant of the television obtains a voice command from the user, the voice command can be parsed through a semantic understanding model inside the television to obtain an analysis result. It can be understood that the analysis result contains the intention of the user, and then the analysis result containing the intention of the user is sent to the television. The television can execute a corresponding operation according to the analysis result for the voice command, so that the display apparatus 200 performs an action matching the intention contained in the voice command of the user.

In some embodiments, the voice assistant can support multiple languages, and the user can choose an appropriate language to interact according to his/her language habit. When there is a new language, the voice assistant can update a language list in the display apparatus 200 by means of cloud configuration. Taking the display apparatus 200 as a television as an example, when a new language is developed and tested, through an operation configuration in the cloud, an operation platform can be set in the cloud, such as the server 400. After the operation platform completes configuration of the new language, the television can automatically update the language list through the cloud every time the television is turned on or enters a voice interface. In this way, the user can select a desired language in a voice setting interface, and execute a corresponding voice function through the selected language.

In some embodiments, the operation platform can set a default language for each country. When the user selects a country and activates the voice assistant, the television can automatically select a default language for the user. For example, after the television gets a language list from the cloud, the language list can be stored locally. When the user selects a corresponding country, the television can select a default language corresponding to the country.

Although the above method can realize a requirement of language update and the function of the voice assistant, with continuous expansion of languages and continuous upgrade of functions of the voice assistant, there can still be some problems in the application of voice the assistant. For example, firstly, the language list requirements to be obtained from the cloud, and when the network is not good, there will be a failure to obtain the language list. In this case, the television can use a locally stored language by default, which can affect accuracy and timeliness of language settings. However, when the locally stored language or the language selected by the user is not in a list subsequently obtained from the cloud, after the network is restored, the television can automatically switch to the default language in the cloud, and the process of switching the language cannot be perceived by the user, affecting the user's experience. Secondly, refresh of the language list only occurs when the television is powered on or enters a page of a voice menu, and the user can only see when the language list is updated by entering the voice menu. Because the user generally does not view the voice menu frequently, when a new language is added to a television system through the cloud, the user cannot intuitively perceive language addition or update. Moreover, with upgrade of television products, functions of the voice assistant will continue to enrich. However, due to lack of an intuitive function update prompt, it is often difficult for the user to realize what new functions have been added to the voice assistant. As a result, these new functions cannot be fully utilized to enhance use experience.

Therefore, during the use of the voice service in the display apparatus 200, in terms of language update and function representation, due to the lack of an effective function update prompt mechanism, the user cannot know the change of the language or function of the voice service, which affects the user's experience.

In view of the problem that the user cannot know the change of the language or the function of the voice service, which affects the user's experience, some embodiments of the present disclosure provide a display apparatus 200 including a display 260, a communicating device 220 and at least one processor 250. The display 260 can be configured to display a user interface, the communicating device 220 can be configured to establish a communication connection with a server 400, the processor 250 can be configured to execute an application program to cause the display apparatus 200 to perform a method for a voice service. When there is a new language in the voice service, the display apparatus 200 can remind the user of existence of a newly added language through a prompt page. When a default language selected locally by the user is offline, the user can be reminded through a prompt page that the default language has been offline. When a menu page of the voice service has a new function, the user can be reminded of existence of the new function through a preset identifier, to further solve the problem that the user cannot know the change of the language or the function of the voice service during the use of the voice service, which affects the user's experience.

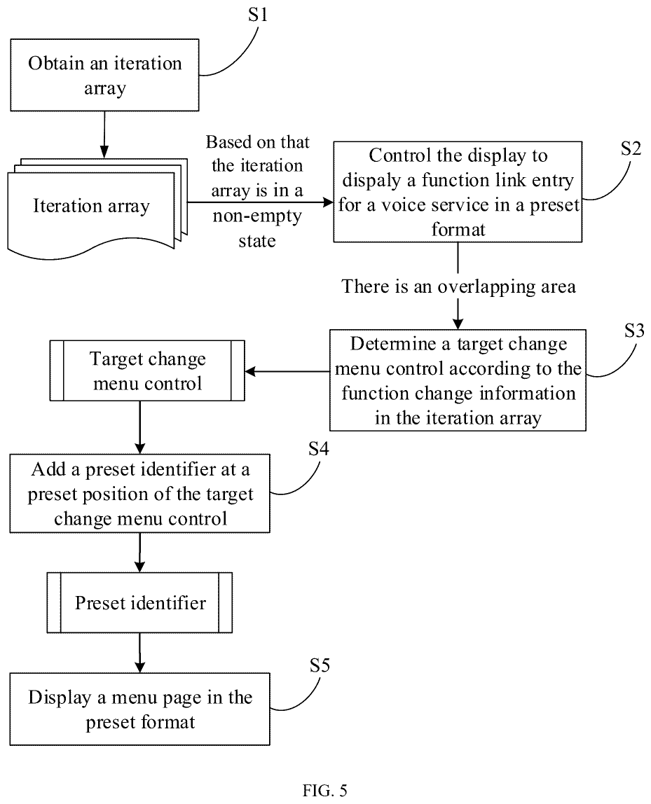

To facilitate understanding of embodiments of the present disclosure, each step is described in detail below with reference to some specific embodiments and attached drawings. FIG. 5 is a flowchart of a method for a display apparatus to perform a voice service prompt according to embodiments of the present disclosure. In some embodiments, the display apparatus 200 can include following steps S1-S5 when performing the method for prompting the voice service. The details are as follows.

Step S1: The display apparatus 200 obtains an iteration array.

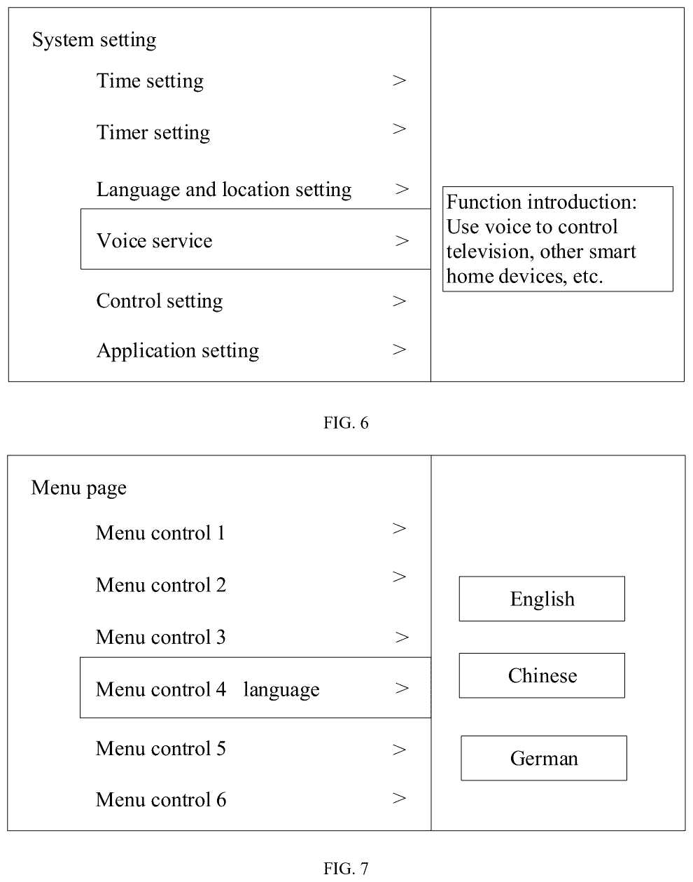

FIG. 6 is a schematic diagram of a function link entry for a display apparatus to access a voice service according to embodiments of the present disclosure. As shown in FIG. 6, in some embodiment, a system setting page can be provided in the display apparatus 200. Time, timer, language and location, voice service, control item, application and other items can be set through the system setting page. Taking the voice service as an example, in response to a click event to a voice service module input from a user, a menu page of the voice service can be entered. In order to facilitate the user's understanding of each module, the system setting page can also be set with function description of each function module. For example, a function of the voice service is to use voice to control a television and other smart home devices.

After accessing the voice service through the function link entry for the voice service, the menu page corresponding to the voice service can be entered. FIG. 7 is a schematic diagram of a scenario in which a menu control is included in a voice service according to embodiments of the present disclosure. As shown in FIG. 7, the menu page can include a plurality of menu controls on the left side, and each menu control can correspond to a plurality of sub-menu controls. For example, a voice service can include a menu control for language, and the menu control for language can include a plurality of sub-menu controls for English, Chinese, German, and the like.

As known from the foregoing description, the display apparatus 200 has a behavior of automatically switching the local language, and the user cannot perceive the switching of the language, which affects the user's experience. In view of this, in some embodiment, in response to a language switch event for switching a language in a voice service, or in response to a list update event for updating a language list, after the display apparatus 200 receives a first input command, the display 260 can be controlled to display a prompt page configured for prompting language change information in the voice service. When the language list is updated and a new language is added, a first reminding message can be generated, and the display 260 can be controlled to display the first reminding message on the prompt page. The first reminding message is used for reminding that the new language is added to the voice service. When the language list is updated and a default language locally set by the user is offline, a second reminding message and a third reminding message can be generated, and the display 260 can be controlled to display the second reminding message and the third reminding message on the prompt page. The second reminding message is used for reminding that the default language is offline, and the third reminding message is used for reminding a target default language currently in use.

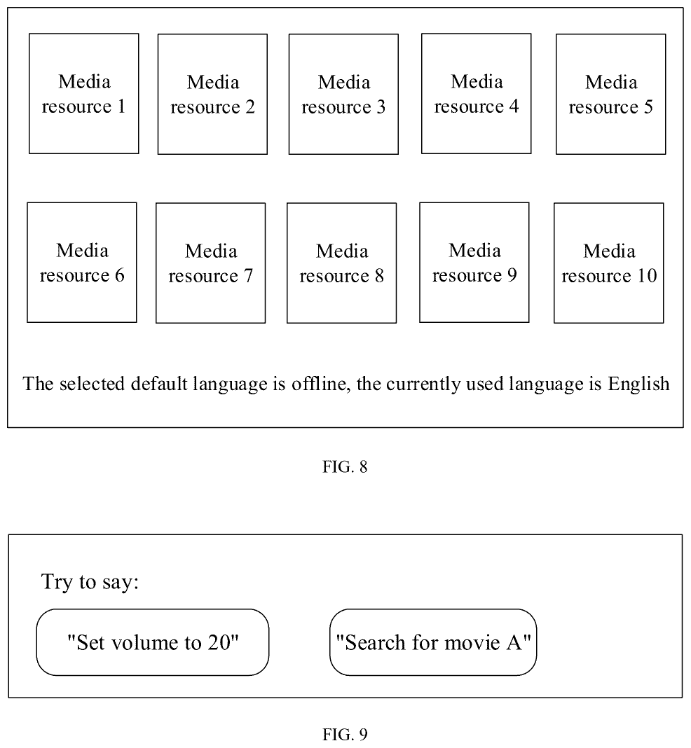

For example, when the default language locally set is not in the language list configured in the server 400, that is, the default language is offline, or the language list in the server 400 is updated, in response to the user pressing a voice key module for the first time, the display apparatus 200 can provide the user with the following prompt page. FIG. 8 is a schematic diagram of an effect of providing a prompt page by a display apparatus according to embodiments of the present disclosure. As shown in FIG. 8, when there is an update to the language list and there is a new language, the user can be prompted by a first reminding message that there is a new language, for example, the first reminding message can be “English is the new language”. When there is an update to the language list and the default language previously selected by the user is no longer online, the user can be prompted by a second reminding message and a third reminding message, for example, the second reminding message can be “the selected default language is offline”, and the third reminding message can be “the currently used language is English”. In this way, when the language of the voice service is automatically switched or the language list is updated, the display apparatus 200 can inform the user of the language update through a prompt page, and the user is informed of the language used by the current voice service and the change information of the language. Through the prompt page, the user can know language changes in time. The display apparatus 200 can provide a clear prompt, so that the user can better understand the voice service and the latest status thereof, improving the user's experience.

In order to determine whether the above language list has been updated, in some embodiments, the display apparatus 200 can obtain an initial language list stored locally in the display apparatus 200 and send a list obtaining instruction to the server 400. The list obtaining instruction is configured to request a latest cloud language list from the server 400. When the initial language list is inconsistent with the cloud language list, it can be determined that the language list is updated.

For example, the display apparatus 200 can read a stored initial language list from a local storage such as a database, a file system, or a memory cache, which can be realized by querying the database or reading a configuration file. A list obtaining instruction can then be sent to the server 400 using a network request, such as an HTTP request, to request the latest cloud language list. After obtaining, the language list stored locally is compared with the cloud language list obtained from the server 400. When the languages in the language list stored locally and the cloud language list are not exactly the same, for example, there are additions, deletions, or modifications, the language list can be considered to be updated. In this way, the update of the language list can be determined.

In order to facilitate the user to view the menu page, in some embodiments, the user can enter the menu page through the voice key module. For example, the user can input a voice command such as “open a menu page of a voice service,” the display apparatus 200 can respond to the voice command, and can directly jump to the menu page of the voice service without the need for the user to enter the menu page layer by layer, which is convenient for the user to operate.

In some embodiments, after the prompt page has been displayed for a preset duration, the display apparatus 200 can control the display 260 display a voice interaction page, and obtain a voice command based on the voice interaction page from the user; perform a function corresponding to the voice command in response to the voice command.

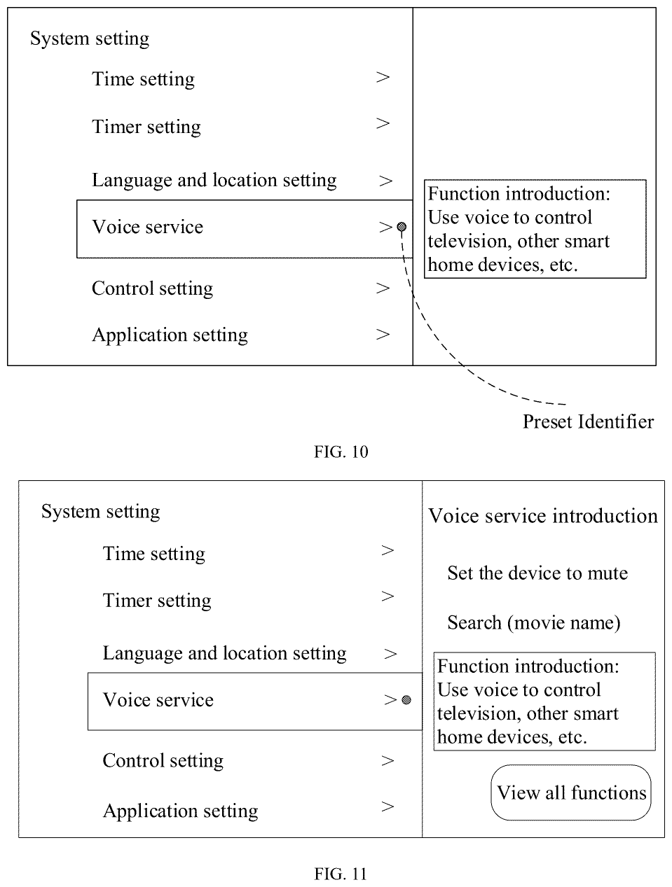

For example, the prompt page includes reminding information, and the prompt page has been displayed for a preset duration. This duration allows the user to read and understand the reminding information. For example, the preset duration can be 2 seconds, and the display apparatus 200 can automatically jump to the voice interaction page after 2 seconds. FIG. 9 is a schematic diagram of an effect of a voice interaction page according to embodiments of the present disclosure. As shown in FIG. 9, in the voice interaction page, voice interaction commands can be provided for the user to refer to, the voice interaction commands can be “set volume to 20”, “search for movie A”, etc. The user can input corresponding voice commands according to actual requirements. When the user inputs a voice, the display apparatus 200 can capture a voice signal through a built-in or external microphone, and the captured voice signal can then be converted into a text command using a speech recognition related algorithm. The display apparatus 200 can parse the converted text command to determine the user's intention and an operation to be performed. According to the parsed voice command, the display apparatus 200 can invoke a corresponding function module or service to perform an operation, for example, open an application, search for information, control a smart home device, etc. In this way, the user can intuitively interact with the display apparatus 200 through the voice command, and the interaction efficiency is improved.

In some embodiments, the voice service can correspond to different versions. When there is a new function in the voice service, for example, when a menu control is updated or a sub-menu control in the menu control is updated, the display apparatus 200 can generate a version of a corresponding language service. Taking the display apparatus 200 as a television for example, after the television is upgraded, when a version of the voice service is changed, it indicates that there is a function change in the voice service.

In view of this, in order to track whether there is an update to the function of the voice service, in some embodiments, the display apparatus 200 can set an iteration array. The iteration array can be used for representing function change information of a menu control in a menu page of a voice service. For example, the iteration array can be updateState. In this way, the display apparatus 200 can track whether the voice function has iteration through the updateState array. When it is detected that the updateState array is not empty, an identifier can be added on the menu control of the voice service to prompt the user that the voice service has new functions.

In some embodiments, the display apparatus 200 can create an iteration array and set an initial value of the iteration array as a null value, and fill the iteration array according to the function change information of the voice service.

For example, the display apparatus 200 can create an updateState array for storing the function change information of the voice service. This array is the iteration array. The iteration array allows the display apparatus 200 to dynamically add, remove, or modify elements in the array, to reflect the real-time status of the function of the voice service. Then an initial value can be set for the updateState array. For example, the initial value of the updateState array can be null [ ], to ensure that the iteration array does not display any change information until a change in function is detected. When the function of the voice service changes, such as adding, updating, or deleting, a television system can update the iteration array based on the change information. For example, when the voice service adds a new voice command or supports a new language, the television system can add this change information as a new element to the iteration array. Conversely, when an existing feature is removed or updated, the television system can remove a corresponding element from the array or modify a state of the element. In this way, the iteration array can provide a flexible way to manage and notify the user about changes in the function of the voice service. By maintaining an iteration array, the television system can quickly notify the user when there is a new function update, and can also ensure that only relevant and latest information is displayed in the user interface.

After the iteration array is created and filled, the array can become non-empty, that is, there can be function changes in the menu page of the voice service, and the display apparatus can directly obtain the iteration array. By parsing the state of the iteration array, it can be determined whether there is a function update. After the step S1 is completed, the following step S2 can be included.

Step S2: Based on that the iteration array is in a non-empty state, the display apparatus 200 controls the display 260 to display a function link entry for a voice service in a preset format.

When it is detected that the iteration array is in a non-empty state, it indicates that a function of the voice service has changed. The display apparatus 200 can control the display 260 to display the function link entry for the voice service in the preset format. The function link entry is used for accessing a menu page of the voice service. The preset format is a format other than a format displayed in the menu page before a function of the menu control is changed.

In some embodiments, the display apparatus 200 can access a menu page of a voice service through a function link entry. The user can enter the menu page by clicking or touching the function link entry. When the display apparatus 200 detects that the iteration array is in a non-empty state, the function link entry for the voice service can be rendered on the display 260 in a preset format such as a particular size, color, shape. For example, a rendering module can be provided in the display apparatus 200, a menu page can be rendered according to a preset mode such as a font size, a color, a size, a layout, etc.

FIG. 10 is a schematic diagram of a scenario in which a display apparatus displays a function link entry for a voice service in a preset format according to embodiments of the present disclosure. As shown in FIG. 10, in some embodiment, the display apparatus 200 can use an updateState array to track and mark iterations of a voice function of the voice service. The display apparatus 200 can add an identifier on a menu control of the voice service. Compared with FIG. 6, when the voice service has no update function, the rendering function is not performed. When a function of the voice service is updated, the display apparatus 200 can render a solid circle (or other shapes) on the right side of the voice service module. In this way, the display apparatus 200 can intuitively present the function link entry for the voice service to the user, prompt the user that the voice service has an updated function, solving the problem that the user cannot know the change of language or function of the voice service, which affects the user's experience. After the step S2 is completed, the following step S3 can be included.

Step S3: The display apparatus 200 determines a target change menu control according to the function change information in the iteration array.

In some embodiments, the function change information can include a plurality of items, for example, can include first-time upgrade version information, menu identification information and target menu control information, and can also include other information. Specific content of the function change information depends on actual requirements. The updateState array can be filled when the following scenarios are met. In this way, the updateState array changes from the initial null value to a non-null value. The following describes filling of the iteration array.

In some embodiments, when filling the iteration array, the display apparatus 200 can first obtain initial version information of the voice service, in response to an Over The Air (OTA) upgrade event, obtain first-time upgrade version information of the voice service, and fill the iteration array according to the first-time upgrade version information when the initial version information is different from the first-time upgrade version information.

For example, the display apparatus 200 can store the initial version information of the voice service locally after obtaining the initial version information. After the OTA upgrade event is completed, the display apparatus 200 can obtain version information of the voice service again, that is, the first-time upgrade version information. When the initial version information is different from the first-time upgrade version information, it indicates that the voice service has been updated. For this scenario, the display apparatus 200 can fill the iteration array according to the first-time upgrade version information. For example, after the OTA upgrade, when it is detected for the first time that the upgrade version information is AID, the updateState array is filled with ‘AID’ data. For example, the updateState data is changed to [′AID′] after filling. When the initial version information and the first-time upgrade version information are the same, it indicates that the voice service has not changed and no action is required.

In some embodiments, when filling the iteration array, the display apparatus 200 can first obtain a menu control in a menu page: detect a newly added menu in the menu control after the OTA upgrade event is completed, generate menu identification information according to the newly added menu, fill the menu identification information into the iteration array, and control the display 260 to display the menu page in the preset format according to the menu identification information.

For example, after the OTA upgrade event is completed, the display apparatus 200 can perform a series of operations to update the menu page, and ensure that the new menu control is properly displayed and managed. The display apparatus 200 can first retrieve current menu page data from a storage or memory of the display apparatus 200, for example, the current menu page data can include a menu control and a related attribute thereof, and a name, an icon and a function of the menu control, etc. Then, a new menu in the menu control is detected. The menu page after the upgrade can include a new menu control. The display apparatus 200 can compare the menu control data before and after the upgrade to identify which is the newly added menu control. In response to a newly added menu in the menu control, the display apparatus 200 can generate menu identification information. For each newly added menu control, the display apparatus 200 can generate unique menu identification information. The menu identification information can include data such as an ID, a position, a function description, and the like of the menu control, to ensure that each menu control is accurately identified and tracked. The display apparatus 200 can add the newly generated menu identification information to the iteration array, and control that display 260 to display the menu page in the preset format according to the menu identification information.

FIG. 11 is a schematic diagram of a scenario in which a menu control is added to a display apparatus according to embodiments of the present disclosure. As shown in FIG. 11, in some embodiments, each time a menu control is added to a menu page, the display apparatus 200 can fill the updateState array with menu identification information corresponding to the menu control. In FIG. 11, the left area is the menu control of the menu page. After the OTA upgrade, the display apparatus 200 can detect whether there is a newly added menu control, for example, “ABC” is a newly added menu control, then the updateState data after filling can be [ . . . , ‘ABC’]. Meanwhile, the display apparatus 200 can display the new menu control in a preset format, for example, the new menu control can be displayed with a border, rendered with a solid circle on the right, or displayed in other forms. In this way, after the OTA upgrade, the display apparatus 200 can intuitively see the newly added menu control, to prompt the user for new additions to the menu page.

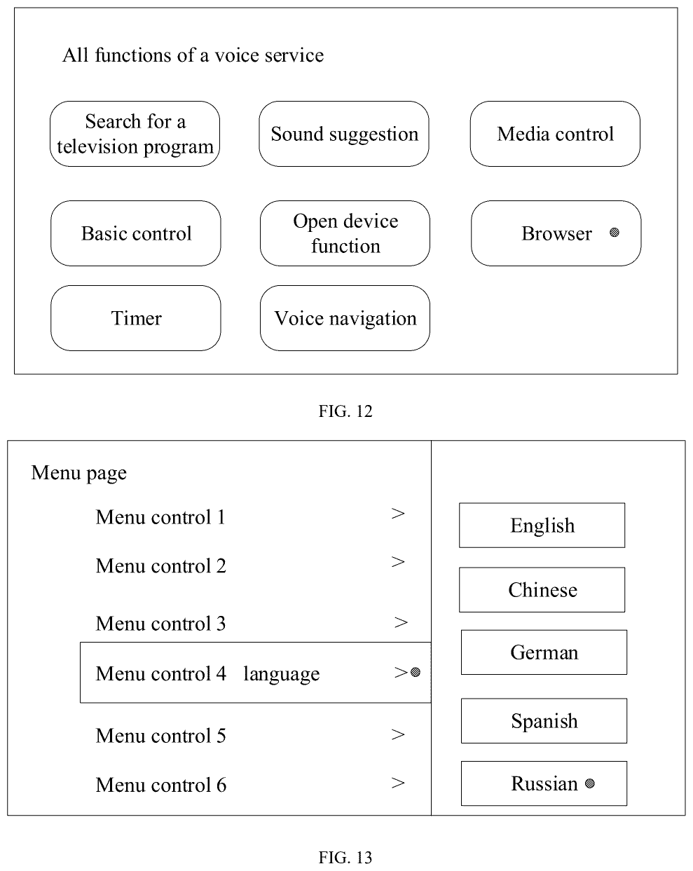

FIG. 12 is a schematic diagram of a scenario of viewing all function modules according to embodiments of the present disclosure. In combination with FIG. 11 and FIG. 12, it can be understood that the size of the menu page is limited, so each menu control has a limited description of its function in the right area. In order to facilitate viewing all functions to which respective menu controls correspond, in some embodiments, function modules for viewing all functions can be set in an introduction bar on the right side of the menu control. In response to a click event of a user on a function module, the display apparatus 200 can be linked to all functions included in the menu control shown in FIG. 12. In this way, the user can visually view all the functions contained in each menu control and improve the user's experience.

In some embodiments, when filling the iteration array, the display apparatus 200 can first monitor change information of a sub-menu control contained in the menu control to detect change of the sub-menu control, add a first label to the changed sub-menu control, determine a target menu control corresponding to the sub-menu control; adding a second label to the target menu control; filling target menu control information corresponding to the target menu control into the iteration array; and control the display 260 to display the menu page in a preset format according to the first label and the second label.

For example, the display apparatus 200 can periodically check whether a sub-menu control under each menu control is added, deleted, or modified, to detect changes in the menu structure. When detecting that a sub-menu control is changed, for example, the sub-menu control is newly added or modified, the display apparatus 200 can add a first label to the changed sub-menu control for recording that the sub-menu control has changed. For each changed sub-menu control, the display apparatus 200 can determine which target menu control is affected by the change, that is, which parent menu control does the changed sub-menu control belong to, where the parent menu control is the target change menu control. In this way, the display apparatus 200 can accurately identify the menu control with changed function, to provide an accurate basis for subsequent operations. After the step S3 is completed, the following step S4 can be performed.

Step S4: The display apparatus 200 adds a preset identifier at a preset position of the target change menu control.

After the target change menu control is determined, the display apparatus 200 can add a preset identifier at a preset position of the target change menu control. The preset identifier is used for indicating existence of change information of the target change menu control. For example, a preset identifier can be added to a preset position, such as the right position of the target change menu control. In this way, after entering the menu page, the user can visually see the identifier beside the menu control, such as highlighting, flashing, or other special icons. The function of which menu control is changed is intuitively prompted to the user through a preset identifier, so that the user can conveniently and quickly find the changed menu control.

In some embodiments, after the display apparatus 200 adds a first label to the changed sub-menu control, a second label can be added to the target menu control corresponding to the sub-menu control, to distinguish which menu control is affected by change of the sub-menu change. The display apparatus 200 can then fill the iteration array with target menu control information. In this way, the iteration array can store a historical state and latest change of the menu control, which can be used to maintain the update of the menu page. Finally, based on the first label and the second label, the display apparatus 200 can identify which menu control and sub-menu control have changed, and then update and display the menu page according to the preset format.

For example, FIG. 13 is a schematic diagram of a scenario of updating a sub-menu control according to embodiments of the present disclosure. As shown in FIG. 13, when a sub-menu control in the menu control is updated, the display apparatus 200 can fill the array with the target menu control information corresponding to the sub-menu control. For example, taking the language menu control as an example, the language initially included in the menu control can be configured by cloud of the server 400. In the later use process, the cloud can update, such as add, delete, and modify the language. When it is detected that the cloud language list is updated and there is a newly added language, a label can be added to the newly added language. When Russian as shown in FIG. 13 is a newly added language, a label is added to Russian. At the same time, a label is added to a menu control corresponding to Russian, i.e., the language menu control. For a change in the sub-menu control, the display apparatus 200 can add “language” to the updateState array. At the same time, the changed part is displayed in a preset form, for example, the changed part is rendered on the right side of the function module in a solid circle to add a preset identifier. In this way, when displaying a menu page, the display apparatus 200 can reflect the latest menu structure, including all newly added or modified sub-menu controls, optimizing the display logic, to solve the problem that the user cannot know the change of the language or function of the voice service, which affects the user's experience.

That is to say, when the display apparatus 200 fills the updateState array, there are at least following scenarios. One of the scenarios is that: after the OTA upgrade, when it is detected that the version of the voice service is updated, for example, changed into AID, ‘AID’ is added into the updateState array. One of the scenarios is addition of a menu control in a menu page, when a new menu control, such as ABC, is added to the menu page, a name of the menu control is added to the updateState array. One of the scenarios is update of a sub-menu control, when a menu control, such as the language menu control, is updated, for example, a new language is added, a name of a first-level menu control, such as' language’, is added to the updateState array. It can be understood that the updateState array is also checked and updated each time the display apparatus 200 is powered on, to ensure timeliness of menu page updates and prompts. After the step S4 is completed, the following step S5 can be included.

Step S5: The display apparatus 200 controls the display 260 to display a menu page in the preset format according to the preset identifier.

In order to prompt the user which functions in the menu page are changed, in some embodiments, the display apparatus 200 can control the display 260 to display a menu page in a preset format according to a preset identifier. For example, for a menu control and a sub-menu control with changed functions, such as a new menu control is added, or a sub-menu control in a menu control is changed, a rendering module in the display apparatus 200 can render the changed part in the menu page according to the preset format, to ensure that the content of the function change is highlighted in the menu page, so that the user can clearly and intuitively understand the change of the language or function of the voice service in the menu page.

To avoid repeated prompts in the menu page, in some embodiments, the display apparatus 200 can perform following functions. In some embodiments, in response to an event for accessing the function link entry from the user, the display apparatus 200 can delete the first-time upgrade version information in the iteration array. In response to an event for accessing the changed sub-menu control from the user, the display apparatus 200 can delete the target menu control information in the iteration array. In response to an event of the user accessing the newly added menu, the display apparatus 200 can delete the menu identification information in the iteration array.

For example, after the user accesses the function link entry, the display apparatus 200 can delete the first-time upgrade version information stored in the iteration array. For example, after the user accesses the function link entry, when there is AID data in the updateState array, the display apparatus 200 can delete the data. When the user finishes accessing a sub-menu control in a menu control, the display apparatus 200 can delete information of the menu control from the iteration array. For example, RU and ES in the language menu control are newly added languages. After the user browses a newly added language, when a focus stays on the language and then leaves, the display apparatus 200 can delete the language in the iteration data. After the user browses a newly added menu control, the display apparatus 200 can delete the menu identification information from the iteration array, to ensure that the newly added menu control is no longer marked as a new function. By deleting the browsed function identifier, repeated prompt to the user can be avoided, and the user's experience can be improved.

The above embodiments provide a display apparatus 200, and the display apparatus 200 can obtain an iteration array used for representing function change information of a menu control in a menu page of a voice service. When the iteration array is detected to be in a non-empty state, the display is controlled to display a function link entry for the voice service in a preset format. The function link entry is used for accessing a menu page of the voice service. A target change menu control is determined according to the function change information in the iteration array. A preset identifier is added at a preset position of the target change menu control. The preset identifier is used for indicating existence of change information of the target change menu control. The display is controlled to display the menu page in the preset format according to the preset identifier. When there is a new language in the voice service, the display apparatus 200 can remind the user of the existence of a newly added language through a prompt page. When a default language selected locally by a user is offline, the user can be reminded that the default language has been offline through the prompt page. When the menu page of the voice service has a new function, the user can be reminded of the existence of the new function through the preset identifier, to further solve the problem that the user cannot know the change of the language or the function of the voice service during use of the voice service, which affects the user's experience.

Based on the display apparatus 200, some embodiments of the present disclosure further provide a method for a voice service. The method can be applied to the display apparatus 200 in the above-described embodiments. In some embodiments, the method can include: obtaining an iteration array used for representing function change information of a menu control in a menu page of a voice service; based on that the iteration array is in a non-empty state, controlling the display to display a function link entry for the voice service in a preset format, where the function link entry is used for accessing a menu page of the voice service; the preset format is a format other than a format displayed in the menu page before a function of the menu control is changed; determining a target change menu control according to the function change information in the iteration array; adding a preset identifier at a preset position of the target change menu control, where the preset identifier is used for indicating existence of change information of the target change menu control; and controlling the display to display the menu page in the preset format according to the preset identifier.

The above embodiments provide a method for a voice service. The method can remind a user of existence of a newly added language through a prompt page when there is a new language in the voice service. When a default language selected locally by the user is offline, the user can be reminded that the default language is offline through the prompt page. When the menu page of the voice service has a new function, the user can be reminded of existence of the new function through the preset identifier, to further solve the problem that the user cannot know the change of the language or the function of the voice service during use of the voice service, which affects the user's experience.

The display apparatus according to embodiments of the present disclosure can have various implementation forms, for example, the display apparatus can be a smart television, a laser projection device, a monitor, an electronic bulletin board, an electronic table, etc., and can also be a mobile phone, a tablet, a smart watch and other devices with a display screen.

The voice assistant is configured to respond to voice that includes specific content. For example, the voice input from a user includes a wake-up word, and the voice assistant can be awakened. For another example, the voice from the user includes power off, and the voice assistant can power off the display apparatus 200 in response to the voice. When the voice from the user does not include these specific contents, the voice assistant does not respond to the voice of the user, or an execution result in response to the voice of the user does not conform to a real intention of the user. For example, when the voice assistant is not awakened, when the voice from the user does not include a wake-up word, the voice assistant cannot be awakened, that is, cannot respond to the user's voice. For another example, after the voice assistant is awakened, when the user wants to power off, but the voice from the user does not include content related to power off, for example, the voice includes standby, the voice assistant can place the display apparatus 200 on standby in response to the voice. However, the execution result does not conform to the real intention of the user to power off.

In order to improve validity and accuracy of the voice from the user, the display apparatus 200 is configured with a voice command learning page, such as a help page for a voice assistant, and the help page includes an example statement that the display apparatus 200 supports a response. The user can learn the example statement through the help page, and when the display apparatus 200 is required to implement a function, a voice containing an example statement corresponding to the function is input, so that the display apparatus 200 can accurately execute a corresponding command.

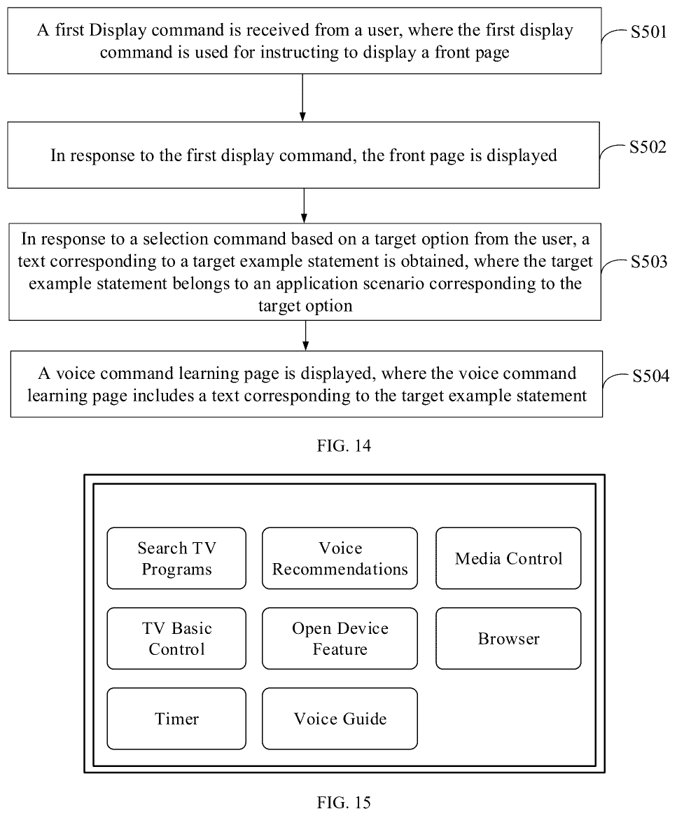

The display apparatus 200 can display the voice command learning page according to the flow shown in FIG. 14, and the specific steps are as follows.

S501: A first display command is received from a user, where the first display command is used for instructing to display a front page.

In some embodiments, the user can input a second display command based on a designated key on a control device 100. For example, the user can press a voice key on the control device 100 to input a second display command to the display apparatus 200. In some embodiments, a system interface of the display apparatus 200 can be configured with a designated icon or option, such as a voice control option, a voice assistant option, a VIDAA VOICE option, etc. The user can click the designated icon or option through the control device 100 to input a second display command to the display apparatus 200. In some embodiments, a setting menu of the display apparatus 200 can be provided with a designated option, such as a VIDAA option, a VIDAA Smart TV option, etc. The user can click on the designated option through the control device 100, to input a second display command to the display apparatus 200. In some embodiments, a shortcut menu of the display apparatus 200 can be provided with a designated shortcut option, such as a voice control option, a voice assistant option, etc. The user can click on the designated shortcut option through the control device 100, to input a second display command to the display apparatus 200.

The second display command is used for instructing to display a voice setting page or a voice setting menu. The voice setting page or the voice setting menu includes a voice command learning option. The user can input the first display command to the display apparatus 200 by clicking the voice command learning option through the control device 100.

S502: In response to the first display command, the front page is displayed.

The front page includes at least one option, and the at least one option corresponds to an application scenario of an example statement. The example statement is voice content to which the display apparatus 200 supports a response. When the display apparatus 200 responds to a voice containing the example statement, the voice is converted into a corresponding text, and the corresponding text includes a text corresponding to the example statement. The display apparatus 200 can analyze semantics corresponding to the text corresponding to the example statement, and determine a corresponding command according to the semantics, to execute the command. It can be seen that an example statement has a corresponding command, and the display apparatus 200 executes the command to implement a corresponding function, that is, the example statement has a corresponding function to be implemented. Application scenarios can be classified according to functions implemented by example statements, for example, the application scenarios can include Search TV Programs, Voice Recommendations, Media Control, TV Basic Control, Open Device Feature, Browser, Timer, Voice Guide, etc.

Referring to the front page shown in FIG. 15, the front page includes at least one option, e.g., Search TV Programs, Voice Recommendations, Media Control, TV Basic Control, Open Device Feature, Browser, Timer, and Voice Guide.

S503: In response to a selection command based on a target option from the user, a text corresponding to a target example statement is obtained, where the target example statement belongs to an application scenario corresponding to the target option.

The user can input a selection command to the display apparatus 200 by clicking on a target option through the control device 100. The display apparatus 200 can determine an application scenario corresponding to the target option in response to the selection command, and obtain a text of the example statement belonging to the application scenario, i.e., the text of the target example statement.

In some embodiments, the display apparatus 200 and obtain the text of the target example statement from the server 400. For example, the display apparatus 200 can send a text request to the server 400 in response to the selection command. The text request is configured to request the text of the example statement of the application scenario corresponding to the target option. The server 400 can determine a target example statement corresponding to the application scenario in response to the text request, and return the text of the target example statement to the display apparatus 200.

In some embodiments, the display apparatus 200 can be configured to locally store the text of the target example statement upon receiving the text of the target example statement, for example, store the text of the target example statement at a first position. In response to a selection command based on the target option from the user, the display apparatus 200 can first identify whether the text of the target example statement exists at the first position. When the text of the target example statement does not exist at the first position, it indicates that the display apparatus 200 is required to obtain the text of the target example statement from the server 400. When the text of the target example statement exists at the first position, it indicates that the display apparatus 200 has obtained the text of the target example statement from the server 400. The text of the target example statement can be obtained directly from the first position without being obtained again from the server 400.

In some embodiments, display apparatus 200 can be configured to delete the text of the target example statement stored at the first position in response to a power down command. In this way, after the display apparatus 200 is powered on every time, when the voice command learning page is displayed, the text of the target example statement is obtained from the server 400 again. In this way, the display apparatus 200 can obtain the text of the latest version of the target example statement from the server 400 in time.

In some embodiments, example statements belonging to the same application scenario can be further divided as intended. That is, example statements belonging to the same application scenario can belong to at least one intention. For example, an example statement belonging to Search TV Programs can belong to a plurality intentions, such as Specific Content, Type, Electronic Program Guide (EPG)/television guide (TV Guide).

In some embodiments, the data returned by the server 400 to the display apparatus 200 also includes related information of the target example statement, such as an application scenario to which the target example statement belongs, an intention to which the target example statement belongs, and a correspondence relationship between the target example statement and the intention, etc.

In other embodiments, the display apparatus 200 can send a text request to the server 400 in response to the first display command, to request the text and related information of the example statement corresponding to each option in the front page from the server 400 at one time.

Taking the front page shown in FIG. 15 as an example, when the user inputs a selection command based on Search TV Programs, the display apparatus 200 can obtain the text of the target example statement belonging to Search TV Programs from the server 400. The target example statement can be attributed to intentions such as specific content, type, and EPG/TV guide. The display apparatus 200 can obtain the text of the target example statement and the related information of the target example statement, and reference can be made to a following data structure example 1 (the data structure example 1 is a simplified data structure, only part of example statements corresponding to the specific content and EPG/TV guide of the intention is shown):

```
“skillCode”: “Search TV Programs”,
“intentGuide”: [
{
“type”: “Specific Content”,
“content”: [
    “search [License] [to] [Restore]”,
    “search for the film [Cross] [Transfer]”,
    “find [Best] [Boys] please”,
    “search [Monster] [Weather] on [YouTube]”,
    “show me [Nice] [Guy] on [YouTube]”,
    “look for [In] [the] [Blue]”,
    “Search for [Game] [of] [Thrones]”,
    “Search for [Game] [of] [Thrones] on [YouTube]”,
    “Play [Game] [of] [Thrones] on [YouTube]”
    ]
  }
{
“type”: “EPG/TV Guide”,
  “content”: [
  “Open [EPG]”,
  “Open program guide”,
  “Show me programs at 8 pm”,
  “Show me the program at 8 pm from Channel 3”
    ]
  }
]
```

Here, “skillCode” is configured to identify an application scenario, “intentGuide” is configured to identify guide by intent, “type” is configured to identify an intention, and “content” is configured to identify a text of an example statement.

S504: A voice command learning page is displayed, where the voice command learning page includes a text corresponding to the target example statement.

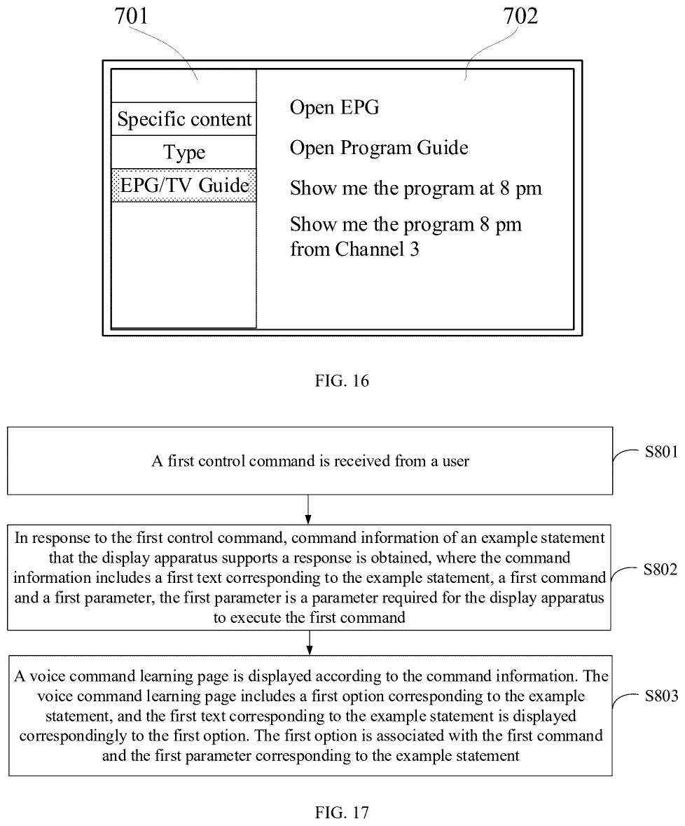

Taking an example that the user selects Search TV Programs in the front page shown in FIG. 15, the display apparatus 200 can display a voice command learning page as shown in FIG. 16. The voice command learning page includes a classification column 701 and a display area 702. The classification column 701 includes intentions to which the target example statement belongs. The display area 702 is configured to display the target example statement corresponding to a selected intention. For example, the target example statement belonging to Search TV Programs is intended to include specific content, type, and EPG/TV Guide. The display apparatus 200 can display the specific content, type, and EPG/TV Guide options in the classification column 701. With the EPG/TV Guide selected by the user, and taking the data structure example 1 shown above as an example, the display apparatus 200 can display the text of the target example statement corresponding to the EPG/TV Guide in the display area 702, such as “Open EPG”, “Open Program Guide”, “Show me the program at 8 pm”, “Show me the program at 8 pm from Channel 3”.

After the user learns the example statement through the voice command learning page, it is still necessary to input a corresponding voice corresponding to the example statement in the form of voice, to interact with the display apparatus 200 through a voice assistant. However, when the control device 100 or the display apparatus 200 used by the user does not well support the voice input function, for example, the control device 100 (such as a remote controller) used by the user does not support a Bluetooth function, and the display apparatus 200 does not support a far-field voice function, or the user is not familiar with the use of the voice assistant, for example, the user cannot quickly and accurately find an entry to open the function of the voice assistant, or the user is not convenient to input voice, etc., even when the user grasps the example statement, the display apparatus 200 still cannot be controlled by voice, and the user's experience is greatly reduced.

In view of the above problems, the present disclosure provides a method for displaying a voice command learning page, so that the user can directly give a command to the display apparatus 200 by clicking an option on the page through the control device 100, and the user does not need to give commands in the form of voice.

The display apparatus 200 can display the voice command learning page according to the flow shown in FIG. 17, and the specific steps are as follows.

S801: A first control command is received from a user, where the first control command is used for instructing to display a voice command learning page.

Before the step S801, the display apparatus 200 can perform steps S8011-S8012 as follows.

S8011: A second control command is received from the user, where the second control command is used for instructing to display a front page of the voice command learning page.

S8012: In response to the second control command, the front page is displayed.

Steps S8011-S8012 are similar to steps S501-S502, and are not described here. In step S8012, the front page includes a second option. The second option is similar to at least one option in the front page in step S502, and corresponds to an application scenario of an example statement.

S802: In response to the first control command, command information of an example statement that the display apparatus supports a response is obtained, where the command information includes a first text corresponding to the example statement, a first command and a first parameter, the first parameter is a parameter required for the display apparatus to execute the first command.

When the front page is displayed, the display apparatus 200 performs step S8021 as follows.

S8021: In response to a first control command based on a target second option from a user, command information is obtained, where the command information includes information of an application scenario corresponding to a target second option.

The command information of the example statement includes the text of the example statement (referred to as the first text for convenience of distinction), and related information of the example statement, such as the application scenario to which the example statement belongs, and the data structure example 1 can be referred to for the intention of the example statement in the application scenario.

In some embodiments, the display apparatus 200 can obtain command information corresponding to an example statement from the server 400 is response to the first control command. For example, the display apparatus 200 can send a request to the server 400 in response to the first control command. The request is configured to request the command information of the example statement of the application scenario corresponding to the target second option. As shown in FIG. 14, the server 400 can determine an application scenario corresponding to the target second option in response to the request, and determine an example statement included in the application scenario and command information corresponding to the example statement. When the server 400 determines the example statement included in the application scenario, the information of the application scenario included in the command information corresponding to the example statement can be identified. When the information of the application scenario included in the command information matches the application scenario corresponding to the target second option, the example statement corresponding to the command information belongs to the application scenario corresponding to the target second option. When the information of the application scenario included in the command information does not match the application scenario corresponding to the target second option, the example statement corresponding to the command information does not belong to the application scenario corresponding to the target second option. The server 400 can return the determined command information to the display apparatus 200.

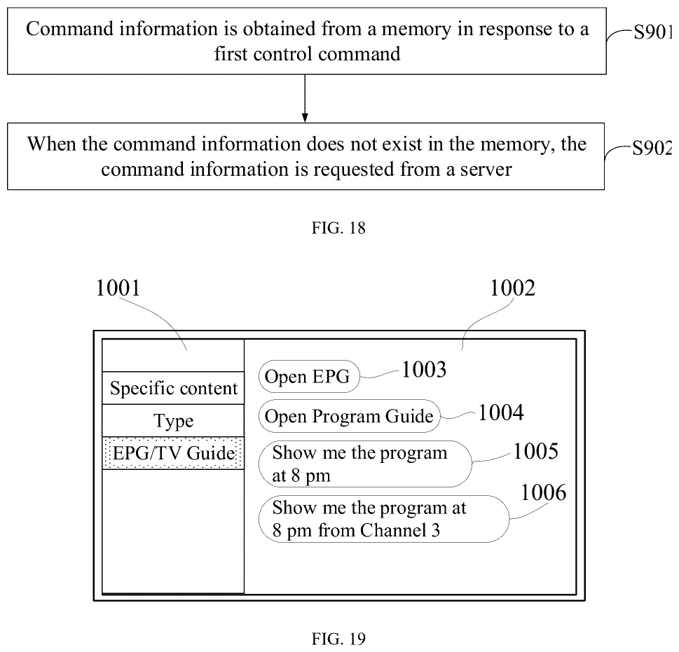

In some embodiments, the display apparatus 200 can be configured to, after receiving the command information sent from the server 400, locally store the command information, such as at a first position. In this way, the display apparatus 200 can obtain the command information according to the flow shown in FIG. 18, and the specific steps are as follows.

S901: Command information is obtained from a memory in response to a first control command.

The display apparatus 200 can first obtain the command information locally, for example, first identify whether the corresponding command information is stored in the memory. When the corresponding command information is stored, it indicates that the display apparatus 200 does not need to obtain the command information from the server 400 again, and the command information can be obtained directly from the memory.

S902: When the command information does not exist in the memory, the command information is requested from a server.

When the corresponding command information is not stored, that is, the command information does not exist in the memory, it indicates that the display apparatus 200 is required to obtain the command information from the server 400.

In some embodiments, the display apparatus 200 can also be configured to delete the command information stored at the first position in response to a power down command, that is, after the display apparatus 200 is powered on every time, when the voice command learning page is displayed, the command information is required to be obtained from the server 400 again. The process of obtaining the command information by the display apparatus 200 can refer to steps S901-S902. The difference from step S902 is that when there is no command information in the memory, it indicates that after this power-on, the display apparatus 200 has not yet displayed the voice command learning page corresponding to the target second option.

In other embodiments, the display apparatus 200 can send a request to the server 400 in response to the second control command, to request the command information of the example statement corresponding to each second option in the front page from the server 400 at one time.

In embodiments of the present disclosure, the command information of the example statement obtained by the display apparatus 200 further includes a first command and a first parameter corresponding to the example statement. The first command is consistent with a command executed by the display apparatus 200 in response to a voice including the example statement. The first command is included in the command information sent from the server 400, that is, the first command is set by the server 400. Therefore, it is not necessary for the display apparatus 200 to determine by analyzing the example statement by itself. The first parameter is a parameter required for the display apparatus 200 to execute the first command. The first parameter is also included in the command information sent from the server 400, that is, the first parameter is set by the server 400. Therefore, it is also not necessary for the display apparatus 200 to determine by analyzing the example statement itself.

Taking the front page shown in FIG. 15 as an example, when the user inputs a selection command based on Search TV Programs, the display apparatus 200 can obtain command information of an example statement belonging to Search TV Programs from the server 400. The example statement can be attributed to intentions such as specific content, type, and EPG/TV Guide. The display apparatus 200 can obtain command information of an example statement, and reference can be made to a following data structure example 2 (the data structure example 2 is a simplified data structure, only part of the example statements corresponding to the specific content of the intention is shown):

```
  “skillCode”: “Search TV Programs”,
  “intentGuide”: [
  {
  “type”: “Specific Content”,
  “content”: [
  {
  “text”: “search [License] [to] [Restore]”,
  “command”: “search”,
  “params”: {“keywords”: [{“type”: “searchField”, “value”: “license to restore”}],
“displayContent”: “license to restore”, “queryText”: “Search license to restore”}
  }
  {
  “text”: “search [spider] [on] [youtube]”,
  “command”: “search”,
  “params”: {“keywords”: [{“type”: “searchField”, “value”: “spider”}],
“displayContent”: “spider”, “queryText”: “Search spider on youtube”, “appName”:
“youtube”}
        }
      ]
    }
  ]
```

Here, “skillCode” is configured to identify an application scenario, “intentGuide” is configured to identify guide by intent, “type” is configured to identify an intention, “content” is configured to identify a text of an example statement, “text” is configured to identify a text corresponding to the example statement, “command” is configured to identify a command corresponding to the example statement, and “params” is configured to identify parameters to which the example statement corresponds.

S803: A voice command learning page is displayed according to the command information. The voice command learning page includes a first option corresponding to the example statement, and the first text corresponding to the example statement is displayed correspondingly to the first option. The first option is associated with the first command and the first parameter corresponding to the example statement.

Each first option corresponds to an example statement, and different first options correspond to different example statements. The display apparatus 200 can display the first text of the example statement on the first option, or the display apparatus 200 can set the first option in the form of the first text, or the display apparatus 200 can display the first text in a region corresponding to the first option, for example, display the first text on the right side of the first option.

The display apparatus 200 can configure the first option to be associated with the first command and the first parameter corresponding to the example statement. In this way, when the user inputs a click command based on the first option, the display apparatus 200 can obtain the corresponding first command and the first parameter based on the association relationship. In some embodiments, the display apparatus 200 can obtain a first command and a first parameter associated with a first option according to the stored command information. For example, the display apparatus 200 can obtain corresponding command information according to the first text corresponding to the first option, where the command information includes the first text, and obtain a command and a parameter (i.e. a first command and a first parameter associated with the first option) in the command information. In other embodiments, the display apparatus 200 can map the first option with a command and a parameter in the stored corresponding command information, and the display apparatus 200 can directly obtain the corresponding command and parameter (i.e., the first command and the first parameter associated with the first option) based on the mapping.

Referring to the voice command learning page shown in FIG. 19, the voice command learning page includes a classification column 1001 and a display area 1002. The classification column 1001 includes intentions to which the target example statement belongs, and the display area 1002 is configured to display the target example statement corresponding to a selected intention. For example, the target example statement belonging to Search TV Programs is intended to include specific content, type, and EPG/TV Guide. The display apparatus 200 can display the specific content, type, and EPG/TV Guide options in the classification column 1001. Take the EPG/TV Guide selected by the user as an example, the display apparatus 200 can display at least one first option of an example statement corresponding to the EPG/TV Guide in the display area 1002, and displaying a first text of an example statement corresponding to each first option. Taking display of the first text of the corresponding example statement on the first option as an example, the first text “Open EGP” is correspondingly displayed for the first option 1003, the first text “Open Program Guide” is correspondingly displayed for the first option 1004, the first text “Show me the 8 pm program” is correspondingly displayed for the first option 1005, and the first text “Show me the 8 pm program of Channel 3” is correspondingly displayed for the first option 1006.

In this way, the voice command learning page can not only provide the text of the example statement for the user to learn the example statement, but also the display apparatus 200 can directly obtain the first command and the first parameter corresponding to the selected first option because the first option in the voice command learning page is associated with the first command and the first parameter. Therefore, the voice command learning page can also provide the user with an entry for inputting a command by clicking in the form of a first option, so that the user can directly give a first command to the display apparatus 200 by clicking the first option through the control device 100, to achieve the same effect as that of giving a first command to the display apparatus 200 by inputting a voice containing a corresponding example statement, so that the user's operation can be effectively simplified.

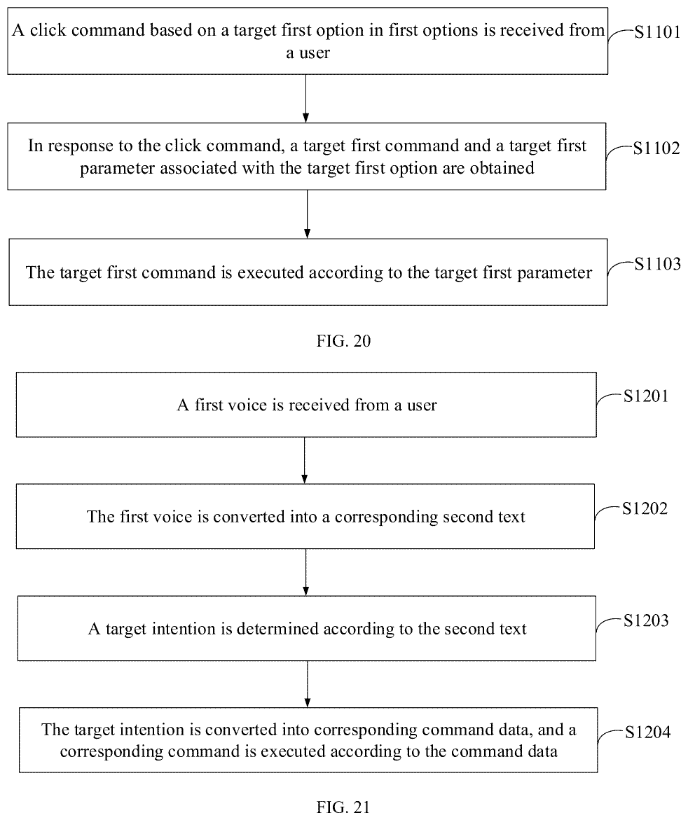

When displaying the voice command learning page, the display apparatus 200 can respond to the first command based on the first option from the user according to the flow shown in FIG. 20, and the specific steps are as follows.

S1101: A click command based on a target first option in first options is received from a user.

The example statement corresponding to the target first option can express the function that the user wants to implement. Taking the control device 100 as a remote controller as an example, the user can move a focus to the target first option through the remote controller, and input a click command to the display apparatus 200 by pressing a confirmation key on the remote controller.

S1102: In response to the click command, a target first command and a target first parameter associated with the target first option are obtained.

The target first option is associated with a target first command and a target first parameter corresponding to an example statement. In response to the click command, the display apparatus 200 can directly obtain the target first command and the target first parameter according to the association relationship between the target first option and the target first command and the target first parameter.

S1103: The target first command is executed according to the target first parameter.

After obtaining the target first command and the target first parameter, the display apparatus 200 can execute the target first command according to the target first parameter to implement the corresponding function indicated by the example statement.

In this way, when the voice command learning page is displayed, the user can continue to use the control device 100 to give the target first command to the display apparatus 200, rather than having to give the target first command in the form of voice, effectively solving the problem that the control device 100 and/or the display apparatus 200 used by the user cannot well support the voice input function, or the user cannot master the voice input function skillfully.

Furthermore, compared to the complicated process in which the display apparatus 200 responds to the first command in the form of voice from the user, in the step S1102, the display apparatus 200 can quickly obtain the stored target first command and the stored target first parameter from the memory based on the association relationship between the target first option and the target first command and the target first parameter. Therefore, the target first command can be quickly executed, and the efficient response to the user instruction is realized.

When the voice command learning page is displayed, the display apparatus 200 can also respond to a first command given by the user through voice according to the flow shown in FIG. 21. The specific steps are as follows.

S1201: A first voice input from a user is received.

After the function of the voice assistant is enabled, the user can send a first command to the display apparatus 200 by inputting a voice. The user can input a first voice to the display apparatus 200 through the control device 100, or, the user can input a first voice in t vicinity of the display apparatus 200 and the first voice can be picked up by the display apparatus 200 through a microphone.

S1202: The first voice is converted into a corresponding second text.

After receiving the first voice, the display apparatus 200 can convert the first voice into a corresponding text, such as a second text. In some embodiments, the display apparatus 200 can be configured with a voice recognition model. The display apparatus 200 can input the received first voice into the model and output the converted second text through the model.

S1203: A target intention is determined according to the second text.

The display apparatus 200 can analyze the second text through a Natural Language Processing (NLP) technique, such as extracting keywords, phrases, grammatical structures, etc., from the second text to infer a target intention of the user, that is, a corresponding target intention of the second text is determined.

S1204: The target intention is converted into corresponding command data, and a corresponding command is executed according to the command data.

The display apparatus 200 can extract relevant parameter information from the second text, for example, the second text is “switch to channel 1”, the extracted parameter information is the channel name “1”. A corresponding command parameter is generated according to the target intention and the extracted parameter information. The command parameter includes a command, a parameter required to execute the command, etc., and a format of the command parameter conforms to execution requirements of the display apparatus 200. The display apparatus 200 can execute the corresponding command according to the parameter in the command data.

In the step S1203, when the second text is an example statement provided in the voice command learning page, the first voice from the user includes a contention corresponding to the example statement. The command data converted in the step S1204 can be the same as the command information corresponding to the example statement. For example, the command data includes a first command and a first parameter. In this way, the display apparatus 200 can execute the first command according to the first parameter in response to a first statement including the example statement, that is, the user can send the first command to the display apparatus 200 in a voice manner.

When the second text is not the example statement provided in the voice command learning page, it indicates that the user does not input the voice according to the example statement, and according to an analysis result of the display apparatus 200 on the intention of the second text, the command data converted in the step S1204 can be the same as the command information corresponding to the example statement provided in the voice command learning page. The intention corresponding to the example statement is consistent with the target intention obtained by analyzing the second text by the display apparatus 200.

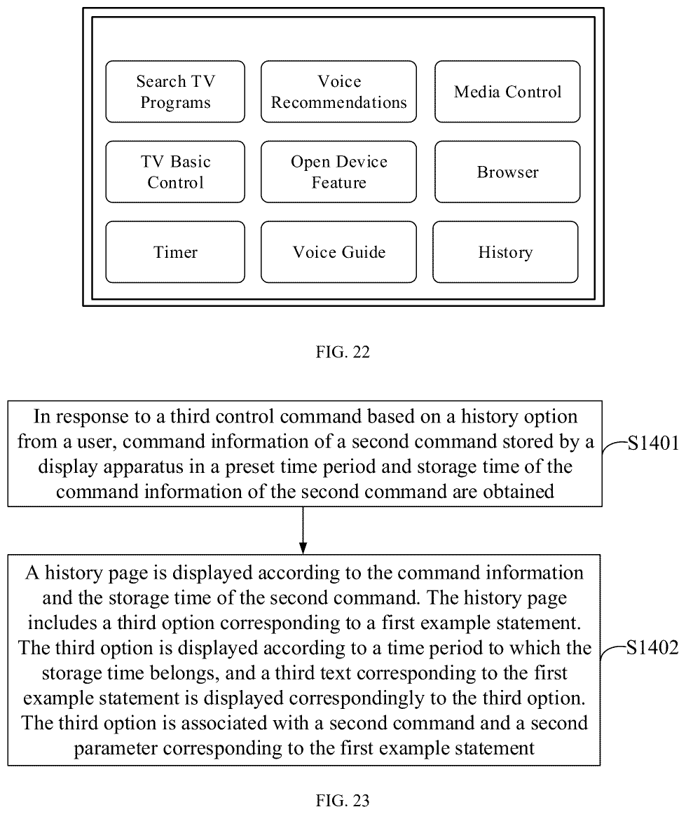

The display apparatus 200 is further configured with a history option on the front page. The history option is to view an entry of a second command received by the display apparatus 200 within a preset time period, that is, an entry to view the second command input to the display apparatus 200 from the user within the preset time period. Referring to the front page shown in FIG. 22, as compared to the front page shown in FIG. 15, the front page shown in FIG. 22 further includes a history option.

The display apparatus 200 can display a history page according to the flow shown in FIG. 23, and the specific steps are as follows.

S1401: In response to a third control command based on a history option from a user, command information of a second command stored by a display apparatus in a preset time period and storage time of the command information of the second command are obtained.

When the user wants to view a command input historically, the user can control the display apparatus 200 to enter the front page through the control device 100, and input a third control command through the control device 100 based on the history option in the front page. For example, the user can move a focus to the history option through the control device 100, and press a confirmation key on the control device 100 to input a third control command to instruct the display apparatus 200 to display the history page.

In response to the third control command, the display apparatus 200 can obtain command information of the second command stored in the preset time period, and obtain the storage time of the command information of the second command.

The second command can be input from a user by inputting a second voice, that is, the second command can be a command given by the user to the display apparatus 200 in a voice manner. The second command can be a command from the user when the display apparatus 200 displays the voice command learning page, and can also be a command from the user when the display apparatus 200 displays other pages. The second voice includes a first example statement in example statements. The second voice including the first example statement can be implemented that: after the display apparatus 200 converts the second voice into a text, the text is the same as the first text corresponding to the first example statement. The second voice including the first example statement can be implemented that: after the display apparatus 200 converts the second voice into a text, the text is different from the first text corresponding to the first example statement, but by analyzing an intention of the text, it can be determined that the intention of the text is the same as the intention corresponding to the first example statement.

And/or, the second command can be from the user by clicking a target option in the first option through the control device 100, that is, the second command is a command from the user when the display apparatus 200 displays the voice command learning page. The target option corresponds to the first example statement. The first example statement corresponding to the target option can be the same as or different from the first example statement included in the second voice.

The display apparatus 200 can receive a second command from the user before performing the step S1301, and locally store command information corresponding to the second command. For example, in response to the second command, the display apparatus 200 can obtain command information corresponding to the second command, and store the command information at a second position and record storage time of the command information. The command information corresponding to the second command includes a first text (referred to as a third text for convenience of distinction) corresponding to the first example statement, a command (referred to as a second command for convenience of distinction) and a first parameter (refer to as a second parameter for convenience of distinction). The second parameter is a parameter required for executing the second command. In this way, when the display apparatus 200 performs the step S1301, the command information whose storage time is within the preset time period can be obtained from the second position.

The preset time period can include N time periods, where N is a positive integer greater than 0. For example, a time period can be 1 day, 1 week, 1 month, etc.

In some embodiments, the N time periods are the most recent N time periods. When the display apparatus 200 correspondingly stores the command information of the second command in a current time period, then the most recent N time periods include the current time period. For example, when a time period is 1 day, N is 3, and today is Nov. 15, 2023, and the display apparatus 200 correspondingly stores the command information of the second command today, then the preset time period is the last three days including today, i.e., Nov. 15, 2023, Nov. 14, 2023 and Nov. 13, 2023.

In some embodiments, the N time periods are the most recent N time periods in which the command information of the second command is stored. For example, when a time period is 1 day, N is 3, and today is Nov. 15, 2023, and the display apparatus 200 correspondingly stores the command information of the second command today, the display apparatus 200 does not store the command information of the second command on Nov. 13, 2023, the display apparatus 200 correspondingly stores the command information of the second command on Nov. 12, 2023, then the preset time period is the last three days excluding the date on Nov. 13, 2023, i.e., Nov. 15, 2023, Nov. 14, 2023 and Nov. 12, 2023.

The display apparatus 200 can dynamically determine N time periods included in the preset time period according to current system time and storage record of the command information of the second command.

In some embodiments, the display apparatus 200 can delete the command information of the second command that does not belong to the preset time period from the second position. In this way, storage pressure of the display apparatus 200 can be reduced.

S1402: A history page is displayed according to the command information and the storage time of the second command. The history page includes a third option corresponding to a first example statement. The third option is displayed according to a time period to which the storage time belongs, and a third text corresponding to the first example statement is displayed correspondingly to the third option. The third option is associated with a second command and a second parameter corresponding to the first example statement.

The step S1402 is similar to the step S803. The third option corresponds to the storage time of the command information of the second command corresponding to the corresponding first example statement. A target time period to which the storage time belongs in a preset time period (N time periods) can be determined according to the storage time. The third option is displayed correspondingly to that target time period, for indicating that the display apparatus 200 stores command information of the second command corresponding to the third option within the target time period. It can also be understood that the user has given the second command to the display apparatus 200 during the target time period.

In some embodiments, the display apparatus 200 can display at most m third options corresponding to each time period in the history page, and m is a positive integer greater than 0. For example, when m is 1, then at most 1 third option is displayed in each time period. For another example, when m is 2, at most 2 third options are displayed in each time period. In this way, when the display apparatus 200 correspondingly stores more command information of the second command in a time period, for a display effect of the history page and the browsing effect of the user, an upper limit is set for the number of third options that can be displayed in each time period, to limit the number of the third options displayed in the history page, reducing energy consumed by the user for browsing the third options.

In some embodiments, when the number of pieces of command information of the second command stored by the display apparatus 200 corresponding to the same time period is M, and M is greater than m, then the m third options displayed by the display apparatus 200 correspond to the m second commands that are most recently stored.

In some embodiments, when duplicate stored command information for a second command occurs within N time periods, only the third option corresponding to the second command with the latest storage time is displayed for the third option of the same second command.

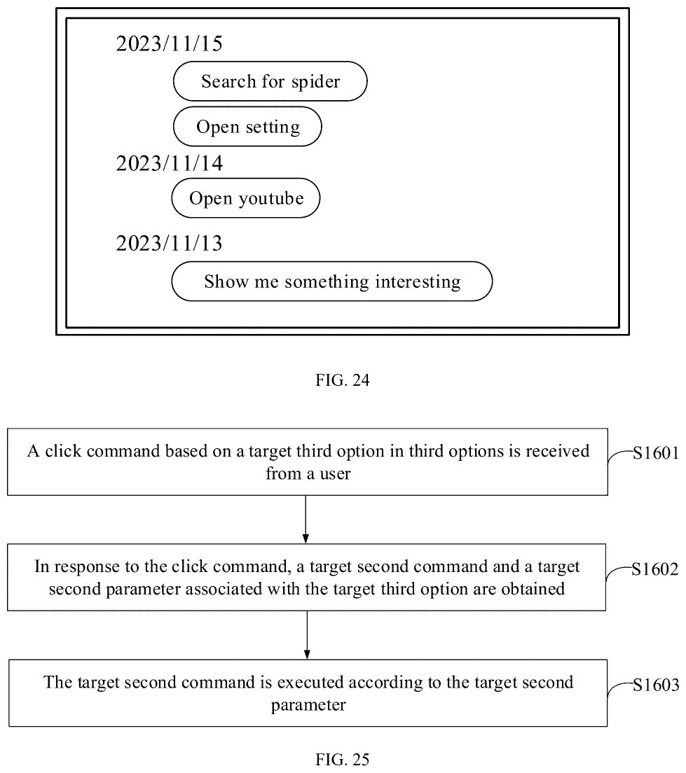

Taking an example that a user clicks a history option in the front page shown in FIG. 22 through the control device 100, when the preset time period is the latest N time periods, N is 3, a time period is 1 day, and today is Nov. 15, 2023, where the display apparatus 200 correspondingly stores the command information of the second command today, and first example statements corresponding to the second command include “Search for spider” and “Open setting”, the display apparatus 200 correspondingly stores the command information of the second command on Nov. 15, 2023, and the first example statement corresponding to the second command includes “Open YouTube”, the display apparatus 200 correspondingly stores the command information of the second command on Nov. 13, 2023, and the first example statement corresponding to the second command includes “Show me something interesting”, then the display apparatus 200 can obtain the command information of the second command stored in the last 3 days and corresponding storage time in response to the click command, and display a history page, such as the history page shown in FIG. 24.

In this way, the user can determine commands sent within the preset time period through the history page. Since the third option is associated with the second command and the second parameter, the display apparatus 200 can directly obtain the second command and the second parameter corresponding to the selected third option. Therefore, the history page can also provide the user with an entry for inputting a command by clicking in the form of a third option, so that the user can directly give a second command to the display apparatus 200 by clicking the third option through the control device 100, to achieve the same effect as that the second command is sent to the display apparatus 200 by inputting a voice containing a corresponding first example statement, so that the user's operation can be effectively simplified.

In some application scenarios, the user can input some commonly used second commands, so that the display apparatus 200 stores history of the second commands. In this way, when the user needs to send these commands, the user can directly find these commands through the history page, and send commands rapidly based on the history page, so that the history page is used as a favorite page of commands.

In some embodiments, when the history page is displayed, the display apparatus 200 can respond to the second command based on the third option from the user according to the flow shown in FIG. 25, and the specific steps are as follows.

S1601: A click command based on a target third option in third options is received from a user.

S1602: In response to the click command, a target second command and a target second parameter associated with the target third option are obtained.

S1603: The target second command is executed according to the target second parameter.

Steps S1601-S1603 are similar to steps S1101-S1103, and are not repeated here.

In some embodiments, when the history page is displayed, the display apparatus 200 can also respond to the second command sent from the user through voice. The specific steps are similar to steps S1201-S1204, and are not repeated here.

For the second command based on the third option from the user and the second command in a voice manner from the user, the display apparatus 200 can be configured to re-store corresponding command information to the second position according to new storage time, to update history data.

Far-field voice is a kind of Artificial Intelligence (AI) voice interaction technology that integrates AI voice search and is widely used in smart TV and smart speakers. The far-field voice can realize voice control without remote control at a distance of 5 meters. The difference between far-field voice and near-field voice is that an operating distance of the far-field voice is generally between 1 meter and 10 meters. The main technical difficulties lie in the processing of multipath reflection, reverberation effect and background noise interference. A front end of the far-field voice generally uses a microphone array to pick up the voice.

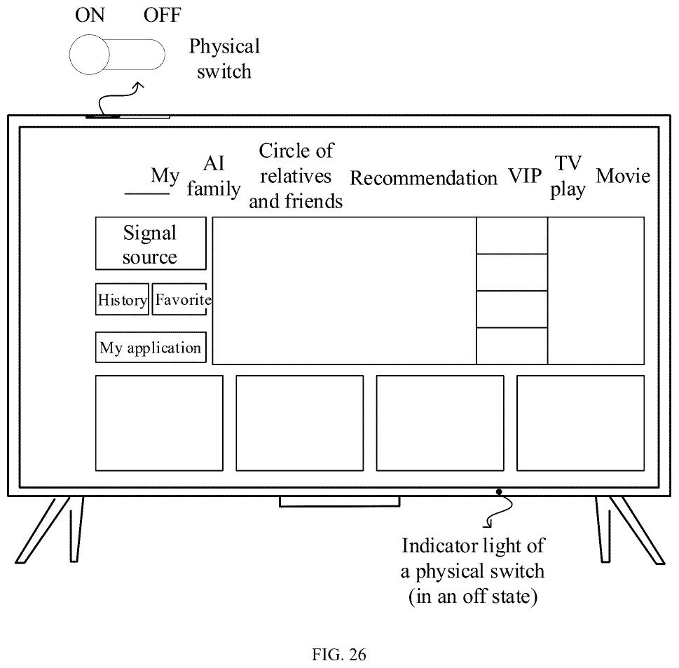

Some smart devices can run in a back end after turning on a far-field voice function. The back end operation of far-field voice function cannot guarantee privacy of a user, and the back end operation of the far-field voice function for a long time is also relatively energy-consuming. A physical switch can be added on the smart device for the far-field voice function. When the far-field voice function is not required, the physical switch of the far-field voice function can be turned off. In this way, the far-field voice function cannot run in the back end, which can protect the user's privacy and reduce energy consumption. The physical switch is a mechanical switch, and the physical switch is opposite to an electronic switch. The electronic switch is an automatic control switch, and the physical switch requires manual control by the user. As shown in an application scenario diagram of a display apparatus of FIG. 26, a physical switch can be provided on a bezel of the display apparatus 200, and a user can control an on/off state of the physical switch by toggling the physical switch.

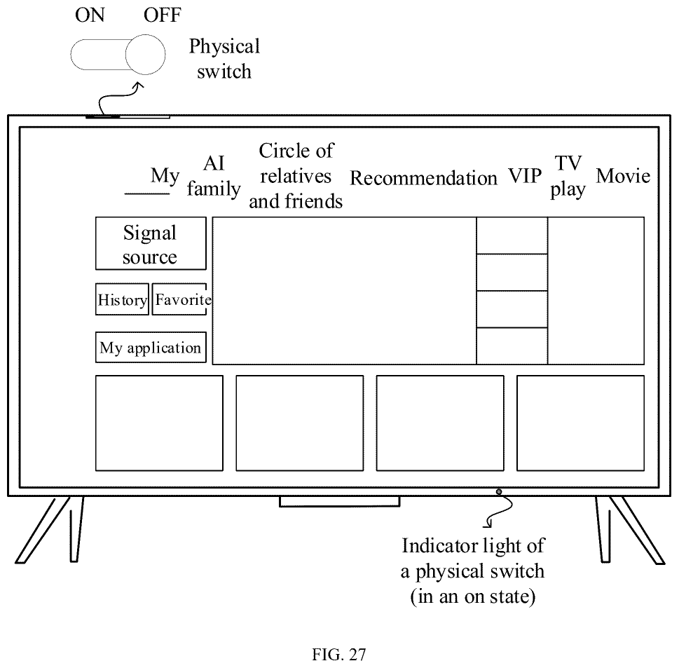

On some smart devices, the physical switch of far-field voice function also has an indicator light. The indicator light is configured to indicate the on/off state of the physical switch. For example, as shown in FIG. 26, when the physical switch of the far-field voice function is in the on state, the indicator light corresponding to the physical switch is in the off state. As shown in FIG. 27, when the physical switch of the far-field voice function is in the off state, the indicator light corresponding to the physical switch is in the on state. That is, when the physical switch for the far-field voice function is in the off state, the indicator light corresponding to the physical switch is always in the on state, for example, the indicator light emits red light. Therefore, when the indicator light does not emit red light, the user can determine that the physical switch of the far-field voice function is in the on state. When the indicator light emits red light, the user can determine that the physical switch of the far-field voice function is in the off state.

However, in the above method for prompting an on/off state of a physical switch, when the on/off state of the physical switch is the off state, the indicator light can continue to emit red light, and the user not only cannot independently select the method for prompting an on/off state of a physical switch, but also the continuous red light of the indicator light can increase the energy consumption of the display apparatus.

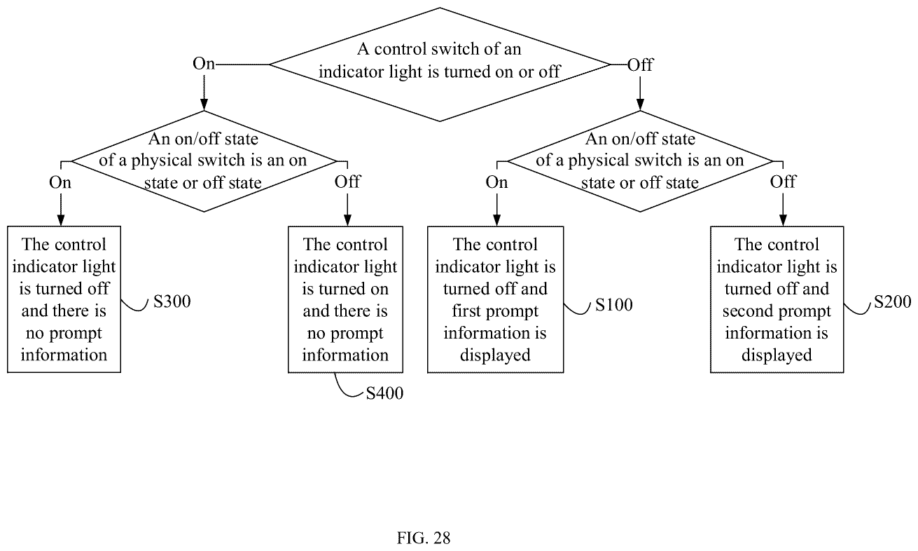

In view of the above issues, some embodiments provide a display apparatus 200 including a display 260 and at least one processor 250. The display 260 is configured to display a user interface. As shown in FIG. 28, the at least one processor is configured to perform a method for prompting an on/off state of a physical switch, including following steps.

Step S100: When the display apparatus 200 is configured to turn off a control switch of an indicator light, the indicator light of the physical switch is always off, that is, different on/off states of the physical switch are prompted through prompt information on the user interface. When the on/off state of the physical switch is the on state, the display is controlled to display first prompt information. The first prompt information is used for prompting that a current on/off state of the physical switch is the on state.

Step S200: When the display apparatus 200 is configured to turn off the control switch of the indicator light, when the on/off state of the physical switch is the off state, the display is controlled to display second prompt information. The second prompt information is used for prompting that the current on/off state of the physical switch is the off state.

The indicator light according to embodiments of the present disclosure is an indicator light for indicating the on/off state of the physical switch. The display apparatus 200 can be configured to turn on the control switch of the indicator light by configuring a setting interface for a control switch corresponding to the indicator light. The control switch of the indicator light can be controlled based on a setting interface for the control switch corresponding to the indicator light.

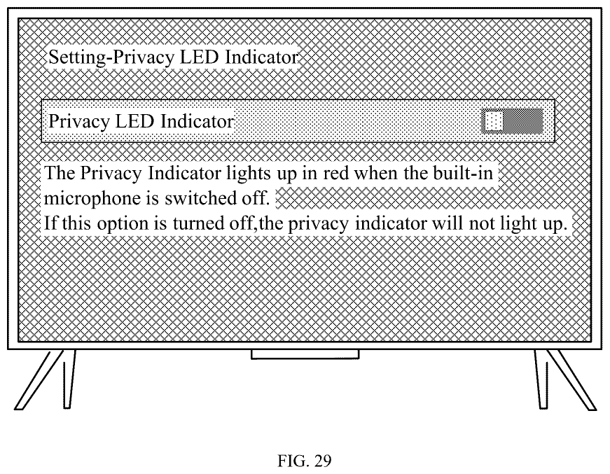

FIG. 29 is a diagram of a setting interface for a control switch corresponding to an indicator light. The user can set the control switch of the indicator light (Privacy LED Indicator) to be on or off in the user interface shown in FIG. 29. For example, in response to the user's input of clicking on a slider of a control switch input from a user, the slider of the control switch slides from the left side to the right side, and the control switch for controlling the indicator light is turned on. In response to the user's input of clicking on the slider of the control switch, the slider of the control switch slides from the right side to the left side, and the control switch for controlling the indicator light is turned off. The setting interface for the control switch of the indicator light can also display description information about the control switch. For example, “The Privacy Indicator lights up in red when the built-in microphone is switched off. If this option is turned off, the privacy indicator will not light up” (When the control switch is set to be on, the indicator light always lights up in red when the physical switch of the far-field voice function is turned off. When the control switch is set to be off, the indicator light will not light up) is displayed. Based on the description information, the user can select to turn on or turn off the control switch of the indicator light as required.

The off state of the control switch of the indicator light represents that the user does not select to indicate the on/off state of the physical switch by the indicator light, instead, the on/off state of the physical switch is indicated using different prompt messages displayed on the user interface. When the control switch of the indicator light is configured to be turned off, the indicator light is always in an off state, different prompt information can be controlled to be displayed on the user interface according to the on/off state of the physical switch.

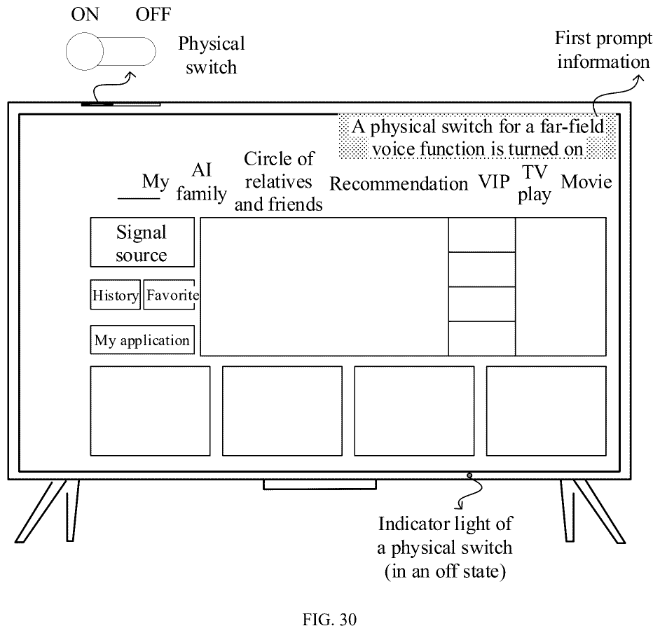

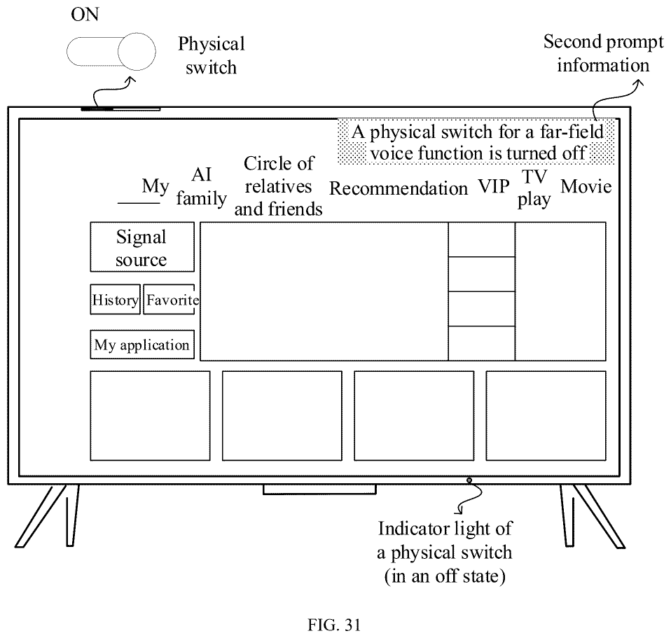

When the user wants to use the far-field voice function or allow the far-field voice function to run in the back end, the physical switch for the far-field voice function can be toggled to the ON side. In response to a user's operation, the physical switch for controlling the far-field voice function is turned on, and in the user interface shown in FIG. 30, first prompt information is controlled to be displayed on the display. The first prompt information is used for prompting that the current on/off state of the physical switch is the on state. When the user does not want to use the far-field voice function and does not need to run the far-field voice function in the back end, the physical switch for the far-field voice function can be toggled to the OFF side. In response to a user's operation, the physical switch for controlling the far-field voice function is turned off, and in the user interface shown in FIG. 31, second prompt information is controlled to be displayed on the display. The second prompt information is used for prompting that the current on/off state of the physical switch is the off state.

When the at least one processor is configured to turn off a control switch of the indicator light, when the on/off state of the physical switch is the on state, the display is controlled to display first prompt information. The specific implementation includes: receiving a signal indicating that the control switch of the indicator light is in an off state from a user interface layer; receiving a signal that the on/off state of the physical switch is an on state from a physical switch interface at a bottom layer, generating a drive signal from the two signals and sending the drive signal to a drive layer, so that the drive layer controls the display to display the first prompt information according to the drive signal.

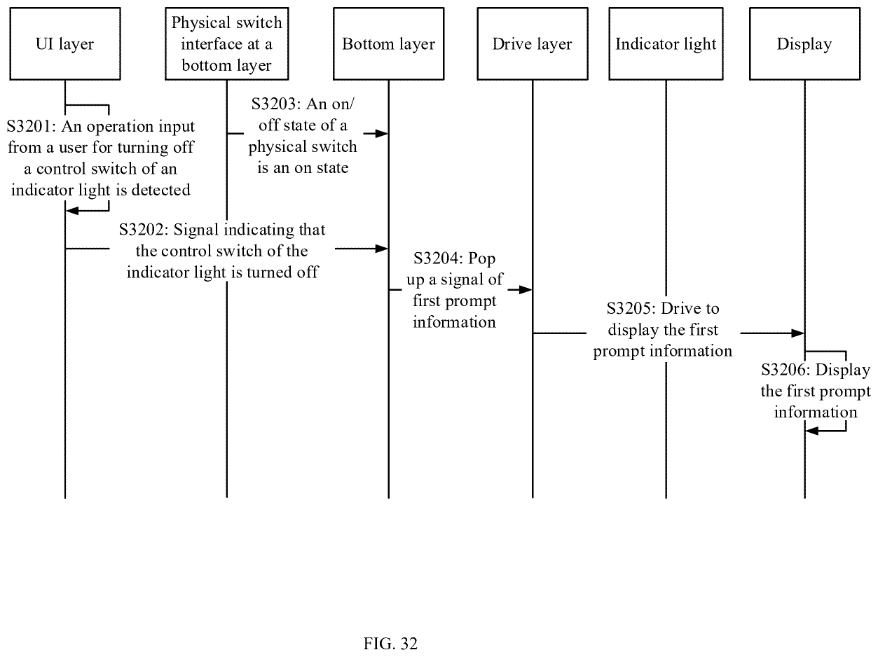

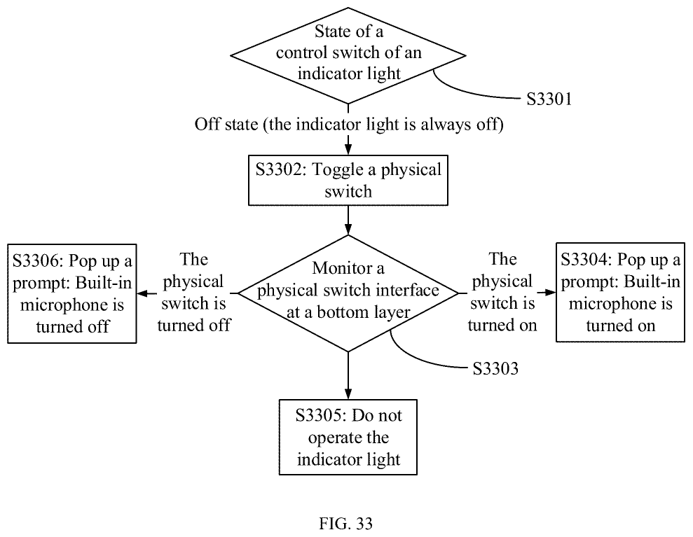

The specific implementation of controlling the display to display the first prompt information is shown in a signaling diagram of FIG. 32 and a flowchart of FIG. 33. The specific implementation process is as follows.

When a user's operation for turning off the control switch of the indicator light on an interactive interface is detected (S3201/S3301), a UI layer (user interface layer) transmits a signal indicating that the control switch of the indicator light is turned off to a bottom layer (S3202). Then the physical switch interface at the bottom layer is monitored (S3303). A user's operation for toggling the physical switch is detected (S3302), in this case, the user's operation for toggling the physical switch is turning on (S3203). In response to the user's operation for turning on the physical switch and a signal of turning off the control switch of the indicator light, a bottom layer interface is called to pop up a prompt: Built-in microphone is turned on (S3204/S3304). The bottom layer transmits a pop-up prompt parameter to the drive layer. The drive layer drives the display to display the first prompt information on the display according to the pop-up prompt parameter (S3205). When the display is driven to display the first prompt information on the display (S3206), a state of the indicator light is not adjusted (S3305).

When the at least one processor is configured to turn off the indicator light, when the on/off state of the physical switch is the off state, the display is controlled to display second prompt information. The specific implementation includes: receiving a signal indicating that the control switch of the indicator light is in an off state from a user interface layer; receiving a signal indicating that the on/off state of the physical switch is an off state from a physical switch interface at a bottom layer, generating a drive signal from the two signals and sending the drive signal to a drive layer, so that the drive layer controls the display to display the second prompt information according to the drive signal.

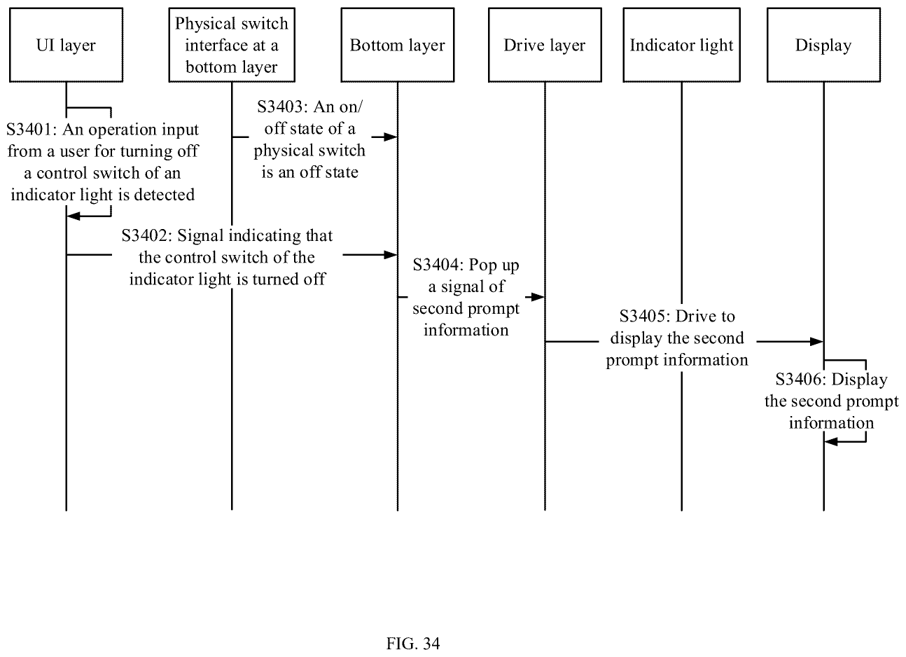

The specific implementation of controlling the indicator light to be off is shown in a signaling diagram of FIG. 34 and a flowchart of FIG. 33. The specific implementation process is as follows.

When a user's operation for turning off the control switch of the indicator light on an interactive interface is detected (S3401/S3301), a UI layer transmits a signal indicating that the control switch of the indicator light is turned off to a bottom layer (S3402). Then, the physical switch interface at the bottom layer is monitored (S3303). A user's operation for toggling the physical switch is detected (S3302), in this case, the user's operation for toggling the physical switch is turning off (S3403). In response to the user's operation for turning off the physical switch and a signal of turning off the control switch of the indicator light, a bottom layer interface is called to pop up a prompt: Built-in microphone is turned off (S3404/S3306). The bottom layer transmits a pop-up prompt parameter to the drive layer. The drive layer drives the display to display the second prompt information on the display according to the pop-up prompt parameter (S3405). When the display is driven to display the second prompt information on the display (S3406), a state of the indicator light is not adjusted (S3305).

Step S300: When the display apparatus 200 is configured to turn on the control switch of the indicator light, the indicator light of the physical switch can be in an off state or an on state, that is, prompt information of different states of the indicator light prompts different on/off state of the physical switch. When the on/off state of the physical switch is the on state, the control indicator light is controlled to be turned off, and the first prompt information and the second prompt information are not displayed on the display.

Step S400: When the on/off state of the physical switch is the off state, the indicator light is controlled to be turned on, and the first prompt information and the second prompt information are not displayed on the display. Therefore, the user can determine the on/off state of the physical switch according to the off or on state of the indicator light, and it is no longer necessary to distinguish according to prompt information on the display.

After the control switch of the indicator light is configured to be turned on, the indicator light can be controlled to be turned off or turned on according to the on/off state of the physical switch. For example, when the user does not want to use the far-field voice function and does not need to run the far-field voice function in the back end, the physical switch for the far-field voice function can be toggled to the OFF side. In response to a user operation, the physical switch for controlling the far-field voice function is turned off and the indicator light is controlled to be turned on. When the user wants to use the far-field voice function or allow the far-field voice function to run in the back end, the physical switch for the far-field voice function can be toggled to the ON side. In response to a user operation, the physical switch for controlling the far-field voice function is turned on and the indicator light is controlled to be turned off.

When the at least one processor is configured to turn on the indicator light, when the on/off state of the physical switch is the on state, indicator light is controlled to be turned off. The specific implementation includes: receiving a signal indicating that the control switch of the indicator light is in an on state from a user interface layer; receiving a signal indicating that the on/off state of the physical switch is an on state from a physical switch interface at a bottom layer, generating a drive signal from the two signals and sending the drive signal to a drive layer, so that the drive layer controls the indicator light to be turned off according to the drive signal.

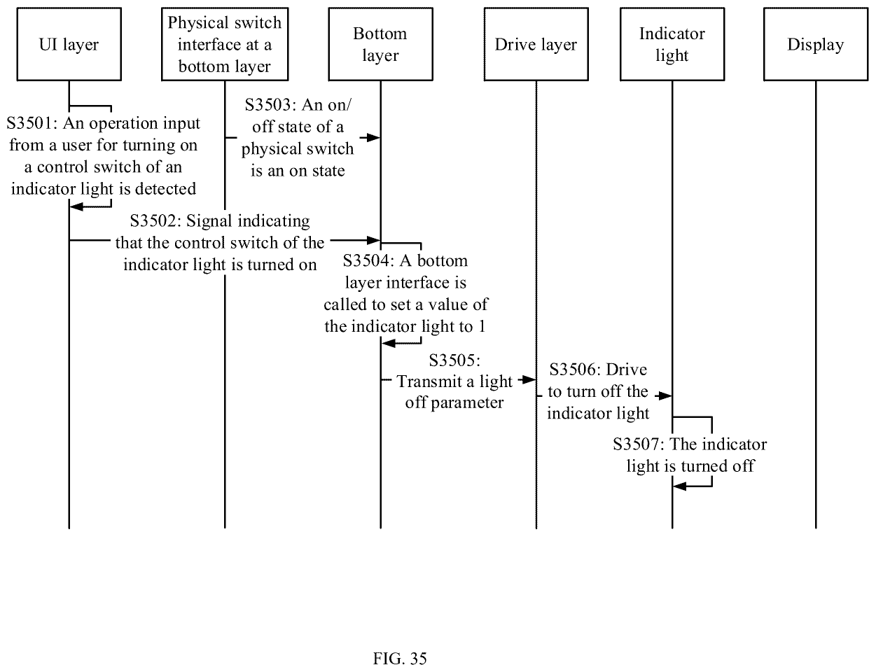

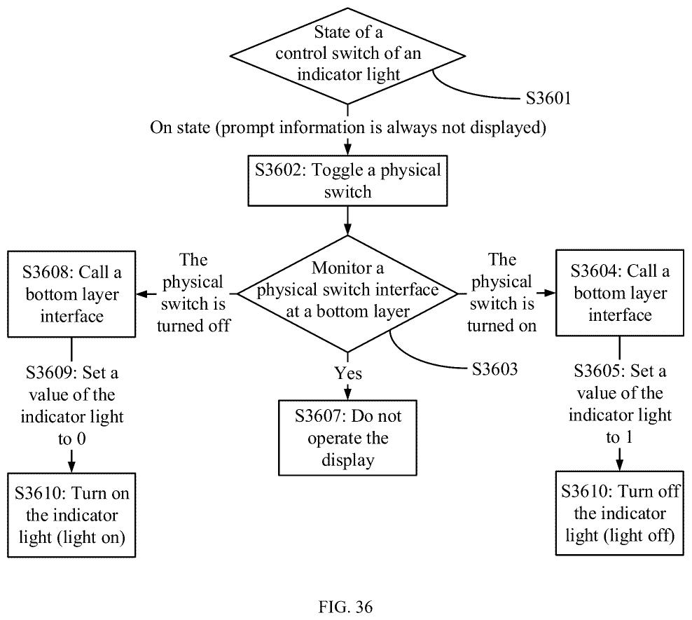

The specific implementation of controlling the indicator light to be turned off is shown in a signaling diagram of FIG. 35 and a flowchart of FIG. 36. The specific implementation process is as follows.

When a user's operation for turning on the control switch of the indicator light on an interactive interface is detected (S3501/S3601), a UI layer transmits a signal indicating that the control switch of the indicator light is turned on to a bottom layer (S3502). Then the physical switch interface at the bottom layer is monitored (S3603). A user's operation for toggling the physical switch is detected (S3602), in this case, the user's operation for toggling the physical switch is turning on (S3503). In response to the user's operation for turning on the physical switch and the signal of turning on the control switch of the indicator light, a bottom layer interface kilby.sl2.i32.avs.privacy.led.indictor.mute is called (S3604) to set a value of the indicator light to 1 (S3504/S3605). The bottom layer transmits a light off parameter to a drive layer according to data 1 (S3505). The drive layer implements hardware control on the indicator light according to the light off parameter (S3506), and the indicator light is turned off (S3507/S3606). When the indicator light is driven to be turned off, content displayed on the display is not adjusted (S3607).

When the at least one processor is configured to turn on the indicator light, when the on/off state of the physical switch is the off state, the indicator light is controlled to be turned on. The specific implementation includes: receiving a signal indicating that the control switch of the indicator light is in an on state from a user interface layer; receiving a signal indicating that the on/off state of the physical switch is an off state from a physical switch interface at a bottom layer, generating a drive signal from the two signals and sending the drive signal to a drive layer, so that the drive layer controls the indicator light to be turned on according to the drive signal.

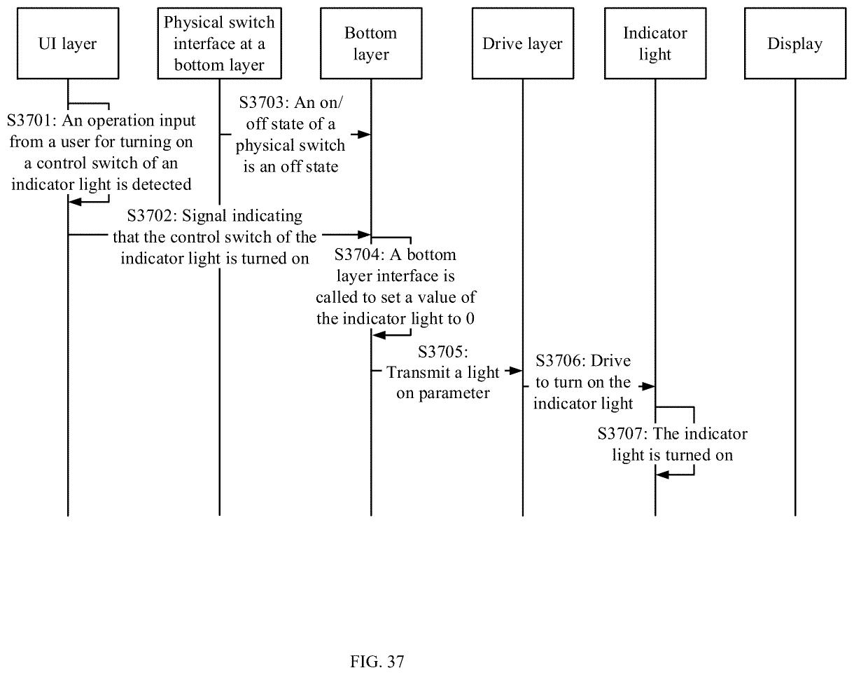

The specific implementation of controlling the indicator light to be turned on is shown in a signaling diagram of FIG. 37 and a flowchart of FIG. 36. The specific implementation process is as follows.

When a user's operation for turning on the control switch of the indicator light on an interactive interface is detected (S3701/S3601), a UI layer transmits a signal indicating that the control switch of the indicator light is turned on to a bottom layer (S3702). Then the physical switch interface at the bottom layer is monitored (S3603). A user's operation for toggling the physical switch is detected (S3602), in this case, a user's operation for toggling the physical switch is turning off (S3703). In response to the user's operation for turning off the physical switch and the signal of turning on the control switch of the indicator light to the bottom layer, a bottom layer interface kilby.sl2.i32.avs.privacy.led.indictor.power is called (S3608) to set a value of the indicator light to 0 (S3704/S3609). The bottom layer transmits a light on parameter to a drive layer according to data 0 (S3705). The drive layer implements hardware control on the indicator light according to the light on parameter (S3706), and the indicator light is turned on (S3707/S3610). When the driving indicator light is driven to be turned on, content displayed on the display is not adjusted (S3607).

In the method for prompting an on/off state of a physical switch and the display apparatus according to above embodiments, when the control switch of the indicator light is configured to be turned off, the indicator light is always off. When the on/off state of the physical switch of the far-field voice function is the on state, the display is controlled to display first prompt information. When the on/off state of the physical switch of the far-field voice function is the off state, the display is controlled to display the second prompt information. When the control switch of the indicator light is configured to be turned on, the first prompt information and the second prompt information are not displayed on the display. When the on/off state of the physical switch of the far-field voice function is the on state, the control indicator light is turned off. When the on/off state of the physical switch of the far-field voice function is the off state, the control indicator is turned on. In this way, a plurality of methods for prompting the on/off state of the physical switch can be provided, and the user can select different prompting methods according to requirements, improving the diversity of the method for prompting the on/off state of the physical switch.

Table 1 shows a list of corresponding relationships between the on/off state of the control switch of the indicator light, the on/off state of the physical switch, the state of the indicator light, and display of prompt information.

| Control switch of | Physical | Indicator | |
|---|---|---|---|
| the indicator light | switch | light | Prompt information |
| On | On state | Off | None |
| On | Off state | On | None |
| Off | On state | Off | First prompt information |
| Off | Off state | Off | Second prompt information |

Table 1 indicates corresponding relationships between the on/off state of the control switch of the indicator light, the on/off state of the physical switch, the state of the indicator light, and display of prompt information.

According to the corresponding relationships in Table 1, when the display apparatus is in a corresponding relationship, when the user changes the state of the control switch of the indicator light or the state of the physical switch, the state prompt method can be switched according to Table 1. A switching process can include following embodiments.

In a first embodiment, when the control switch of the indicator light is configured to be turned on, when the on/off state of the physical switch is the on state, the indicator light is controlled to be turned off (no prompt information is displayed on the display, the on/off state of the physical switch can be concluded to be the on state by combining the off state of the indicator light and no prompt information). In response to an operation command input from a user for switching the on/off state of the physical switch to the off state, the on/off state of the physical switch is controlled to be in an off state, the indicator light is controlled to be turned on, and no prompt information is controlled to be displayed on the display. In this case, the on/off state of the physical switch can be concluded to be the off state by combining the on state of the indicator light and no prompt information.

That is, when the control switch of the indicator light is turned on and the on/off state of the physical switch is the on state, the indicator light is turned off and there is no prompt information. In this case, when the user wants to turn off the physical switch, the physical switch can be toggled from the ON side to the OFF side. In response to a user's operation, the physical switch for controlling the far-field voice function is switched from the on state to the off state. In this case, only the indicator light changes from the off state to the on state. The user can determine that the physical switch is turned off by combing the on state of the indicator light and no prompt information.

The implementation of the first embodiment can be as follows. A user's operation for toggling the physical switch is detected, in this case, the user's operation for toggling the physical switch is turning off. In response to the user's operation for turning off the physical switch and the signal of turning on the control switch of the indicator light, a bottom layer interface kilby.sl2.i32.avs.privacy.led.indictor.power is called to set a value of the indicator light to 0. The bottom layer transmits a light on parameter to a drive layer according to data 0. The drive layer controls the indicator light to change from the off state to the on state according to the light on parameter.

In a second embodiment, when the control switch of the indicator light is configured to be turned on, when the on/off state of the physical switch is the on state, after the indicator light is controlled to be turned off, the control switch of the indicator light is controlled to be turned off in response to an operation command input from a user for turning off the control switch of the indicator light, at the same time, the indicator light is controlled to keep off and first prompt information is controlled to be displayed on the display. In this case, the on/off state of the physical switch can still be concluded to be the on state by combining the off state of the indicator light and the first prompt information (the control switch of the indicator light can also be concluded to be turned off.

That is, when the control switch of the indicator light is turned on and the on/off state of the physical switch is the on state, the indicator light is turned off and there is no prompt information. In this case, when the user wants to turn off the control switch of the indicator light, the setting interface can be entered to set the control switch of the indicator light to be off. In response to a user's operation, the control switch of the indicator light is switched to be turned off. In this case, only the indicator light is kept in the off state, and the first prompt information is displayed. The user can determine that the physical switch is still in the on state by combining the off state of the indicator light and the first prompt information. The control switch of the indicator light can also be concluded to be turned off.

The implementation of the second embodiment can be as follows. A user's operation for turning off the control switch of the indicator light on an interactive interface is detected. In response to the user's operation, a UI layer transmits a signal indicating that the control switch of the indicator light is turned off to a bottom layer. In response to the on/off state of the physical switch being the on state and the signal indicating that the control switch of the indicator light is turned off, a bottom layer interface is called to pop up a prompt: Built-in microphone is turned on. The bottom layer transmits a pop-up prompt parameter to the driver layer. The drive layer drives the display to display the first prompt information on the display according to the pop-up prompt parameter.

In a third embodiment, when the control switch of the indicator light configured to be turned on, when the on/off state of the physical switch is the off state, after the indicator light is controlled to be turned on, in response to an operation command input from a user for switching the on/off state of the physical switch to the on state, the on/off state of the physical switch is controlled to be in the on state and the indicator light is controlled to be turned off, and no prompt information is controlled to be displayed on the display. In this case, the on/off state of the physical switch can be concluded to be the on state by combining the off state of the indicator light and no prompt information.

That is, when the control switch of the indicator light is turned on and the on/off state of the physical switch is the off state, the indicator light is turned on and there is no prompt information. In this case, when the user wants to turn on the physical switch, the physical switch can be toggled from the OFF side to the ON side. In response to a user's operation, the physical switch is controlled to switch from the off state to the on state. In this case, only the indicator light changes from the on state to the off state. The user can determine that the physical switch is turned on by combining the off state of the indicator light and no prompt information.

The implementation of the third embodiment can be as follows. A user's operation for toggling the physical switch is detected, in this case, the user's operation toggling the physical switch is turning on. In response to the user's operation for turning on the physical switch and the signal of turning on the control switch of the indicator light, a bottom layer interface kilby.sl2.i32.avs.privacy.led.indictor.mute is called to set a value of the indicator light to 1. The bottom layer transmits a light off parameter to a drive layer according to data 1. The drive layer controls the indicator light to change from the on state to the off state according to the light off parameter.

In a fourth embodiment, when the control switch of the indicator light is configured to be turned on, when the on/off state of the physical switch is the off state, after the indicator light is controlled to be turned on, the control switch of the indicator light is controlled to be turned off in response to an operation command input from a user for turning off the control switch of the indicator light, at the same time, the indicator light is controlled to be turned off, and the display is controlled to display second prompt information. In this case, the on/off state of the physical switch can be concluded to be the off state by combining the off state of the indicator light and the second prompt information.

That is, when the control switch of the indicator light is turned on and the on/off state of the physical switch is the off state, the indicator light is turned on and there is no prompt message. In this case, when the user wants to turn off the control switch of the indicator light, the control switch of the indicator light can be set to be turned off on the setting interface. In response to a user's operation, the indicator light is controlled to be turned off and second prompt information is displayed on the display. The user can determine that the physical switch is turned off by combining the off state of the indicator light and the second prompt information.

The implementation of the fourth embodiment can be as follows. A user's operation of setting the control switch of the indicator light to be off is detected, a UI layer transmits a signal indicating that the control switch of the indicator light is turned off to a bottom layer. In response to the on/off state of the physical switch being the off state and the signal indicating that the control switch of the indicator light is turned off, a bottom layer interface is called to pop up a prompt: Built-in microphone is turned off. The bottom layer transmits a pop-up prompt parameter to the driver layer. The drive layer drives the display to display the second prompt information on the display according to the pop-up prompt parameter, and a bottom layer interface kilby.sl2.i32.avs.privacy.led.indictor.mute is called to set a value of the indicator light to 1, and the bottom layer transmits the light off parameter to the drive layer according to data 1. The drive layer controls the indicator light to change from the on state to the off state according to the light off parameter.

In a fifth embodiment, when the control switch of the indicator light is configured to be turned off, when the on/off state of the physical switch is the on state, the indicator light is controlled to be turned off. After displaying the first prompt information, in response to an operation for turning on the control switch of the indicator light from the user, the control switch of the indicator light is controlled to be turned on, at the same time, the indicator light is controlled to keep off and the first prompt information is controlled to be hidden on the display. In this case, the on/off state of the physical switch can be concluded to be the on state by combining the off state of the indicator light and no prompt information.

That is, when the control switch of the indicator light is turned off and the on/off state of the physical switch is the on state, the indicator light is turned off and the first prompt information is displayed. In this case, when the user wants to turn on the control switch of the indicator light, the control switch of the indicator light can be set to be turned on on the setting interface. In response to a user's operation, the indicator light is controlled to keep off and the first prompt information is hidden.

The implementation of the fifth embodiment can be as follows. A user's operation of setting the control switch of the indicator light to be on is detected, a UI layer transmits a signal indicating that the control switch of the indicator light is turned on to a bottom layer. In response to the on/off state of the physical switch being the on state and the signal indicating that the control switch of the indicator light is turned on, the bottom layer can transmit a signal of hiding prompt information for display to the drive layer. The drive layer hides the first prompt information on the display according to the signal of hiding the prompt information for display. Therefore, the state in this case is that the indicator light is off and there is no prompt information, and the user can determine that the on/off state of the physical switch is the on state according to the state that the indicator light is off and there is no prompt information.

In a sixth embodiment, when the control switch of the indicator light is configured to be turned off, when the on/off state of the physical switch is the on state, the indicator light is controlled to be turned off. After displaying the first prompt information, in response to an operation command for turning off the physical switch from the user, the physical switch is controlled to be in the off state, at the same time, the indicator light is controlled to keep off and the second prompt information is controlled to be displayed on the display. In this case, the on/off state of the physical switch can be concluded to be the off state by combining the off state of the indicator light and the second prompt information.

That is, when the control switch of the indicator light is turned off and the on/off state of the physical switch is the on state, the indicator light is turned off and the first prompt message is displayed. In this case, when the user wants to turn off the physical switch, the physical switch can be toggled from the ON side to the OFF side. In response to a user's operation, the physical switch is controlled to be switched from the on state to the off state. In this case, the state that the indicator light is turned off and the first prompt information is displayed is changed to the state that the indicator light is turned off and the second prompt information is displayed. The user can determine that the on/off state of the physical switch is the off state according to the combination after the change.

The implementation of the sixth embodiment can be as follows. A user's operation for toggling the physical switch is detected. In this case, the user's operation for toggling the physical switch is turning off. In response to the user's operation to turn off the physical switch and a state that the control switch of the indicator light is turned off, a bottom layer interface is called to pop up a prompt: Built-in microphone is turned off. The bottom layer transmits a pop-up prompt parameter to the driver layer. The drive layer drives the display to display the second prompt information on the display according to the pop-up prompt parameter.

In a seventh embodiment, when the control switch of the indicator light is configured to be turned off, when the on/off state of the physical switch is the off state, the indicator light is controlled to be turned off. After displaying the second prompt information, in response to an operation command for turning on the control switch of the indicator light from the user, the control switch of the indicator light is controlled to be turned on, at the same time, the indicator light is controlled to be turned on, and the second prompt information is controlled to be hidden on the display. In this case, the on/off state of the physical switch can be concluded to be turned off by combining the on state of the indicator light and no prompt information.

That is, when the control switch of the indicator light is turned off and the on/off state of the physical switch is off, the indicator light is turned off and the second prompt information is displayed. In this case, when the user wants to turn on the control switch of the indicator light, the control switch of the indicator light can be set to be turned on on the setting interface. In response to a user's operation, the control indicator light is turned on and the second prompt information is hidden on the display. The user can determine that the physical switch is turned off by combining the on state of the indicator light and no prompt information.

The implementation of the seventh embodiment can be as follows. A user's operation of setting the control switch of the indicator light to be on is detected, a UI layer transmits a signal indicating that the control switch of the indicator light is turned on to a bottom layer. In response to the on/off state of the physical switch being the off state and the signal indicating that the control switch of the indicator light is turned on, a bottom layer interface kilby.sl2.i32.avs.privacy.led.indictor.power is called to set a value of the indicator light to 0, and the bottom layer transmits a light on parameter to the drive layer according to the data 0. The drive layer controls the indicator light to change from the off state to the on state according to the light on parameter, at the same time, the bottom layer can transmit a signal for hiding the prompt information for display to the drive layer. The drive layer hides the second prompt information on the display according to the signal for hiding and the prompt information for display. Therefore, the state in this case is that the indicator light is turned on and there is no prompt information. The user can determine that the on/off state of the physical switch is the on state according to the state that the indicator light is turned on and there is no prompt information.

In an eighth embodiment, when the control switch of the indicator light is configured to be turned off, when the on/off state of the physical switch is the off state, the indicator light is controlled to be turned off. After displaying the second prompt information, in response to an operation command for turning on the physical switch from the user, the physical switch is controlled to be in the on state, at the same time, the indicator light is controlled to keep off, the first prompt information is controlled to be displayed on the display, and the second prompt information is not displayed any more. In this case, the on/off state of the physical switch can be concluded the on state by combining the off state of the indicator light and the first prompt information.

That is, when the control switch of the indicator light is turned off and the on/off state of the physical switch is off, the indicator light is turned off and the second prompt information is displayed. In this case, when the user wants to turn on the physical switch, the physical switch can be toggled from the OFF side to the ON side. In response to a user's operation, the physical switch is controlled to be switched to the on state from the off state. In this case, the state that the indicator light is turned off and the second prompt information is displayed is changed to the state that the indicator light is turned off and the first prompt information is displayed. The user can determine that the on/off state of the physical switch is the on state according to the changed state.

The implementation of the eighth embodiment can be as follows. A user's operation for toggling the physical switch is detected. In this case, the user's operation for toggling the physical switch is turning on. In response to the user's operation for turning on the physical switch and a state that the control switch of the indicator light is turned off, a bottom layer interface is called to pop up a prompt: Built-in microphone is turned on. The bottom layer transmits a pop-up prompt parameter to the driver layer. The drive layer drives the display to display the first prompt information on the display according to the pop-up prompt parameter.

In the first embodiment to the eighth embodiment, after the user switches a single switch in the control switch of the indicator light and the physical switch, in response to a switching operation, the indicator light and the prompt information are adjusted correspondingly. In some embodiments, it is also possible to simultaneously perform switching for both the control switch of the indicator light and the physical switch, and in response to the switching operation, the indicator light and the prompt information is adjusted correspondingly.

In a ninth embodiment, when the control switch of the indicator light is configured to be turned on, when the on/off state of the physical switch is the on state, after the indicator light is controlled to be turned off, in response to an operation command for switching the on/off state of the physical switch to the off state from the user, the on/off state of the physical switch is controlled to be in the off state. At the same time, in response to an operation command for turning off the indicator light from the user, the control switch of the indicator light is controlled to be turned off. In this case, the indicator light is kept off, and the second prompt information is displayed on the display. By combining the off state of the indicator light and the second prompt information, the control switch of the indicator light can be determined to be off, and the on/off state of the physical switch can be determined to be off.

That is, when the control switch of the indicator light is turned on and the on/off state of the physical switch is the on state, the user turns off the physical switch and the control switch of the indicator light at the same time. Therefore, the indicator light is kept off and the second prompt information is displayed according to switching of the control switch of the indicator light and the control switch of the indicator light.

The implementation of the ninth embodiment can be as follows. A user's operation for toggling the physical switch is detected, in this case, the user's operation for toggling the physical switch is turning off, and a user's operation for turning off the control switch of the indicator light on the interactive interface is detected. In response to the operation for turning off the physical switch and the operation for turning off the control switch of the indicator light, a bottom layer interface is called to pop up a prompt: Built-in microphone is turned off. The bottom layer transmits a pop-up prompt parameter to the driver layer. The drive layer drives the display to display the second prompt information on the display according to the pop-up prompt parameter without calling an interface of the indicator light, and it is not necessary to transmit a parameter to the drive layer to enable the drive layer to control the indicator light to update the state, but only to keep the indicator light in the off state.

In a tenth embodiment, when the control switch of the indicator light is configured to be turned on, when the on/off state of the physical switch is the off state, after the indicator light is controlled to be turned on, in response to an operation command input from a user for switching the on/off state of the physical switch to the on state, the on/off state of the physical switch is controlled to be in the on state. At the same time, in response to an operation command input from a user for turning off the control switch of the indicator light, the control switch of the indicator light is controlled to be turned off. In this case, the indicator light is controlled to be turned off, and the display is controlled to display first prompt information. In this case, the on/off state of the physical switch can be concluded to be the on state by combining the off state of the indicator light and the first prompt information.

That is, when the control switch of the indicator light is turned on and the on/off state of the physical switch is the off state, the user turns on the physical switch and turns off the control switch of the indicator light at the same time. Therefore, the indicator light is controlled to be changed from on to off and the first prompt information is displayed according to switching of the control switch of the indicator light of the indicator light and the control switch.

The implementation of the tenth embodiment can be as follows. A user's operation for toggling the physical switch is detected, in this case, the user's operation for toggling the physical switch is turning on, and a user's operation for turning off the control switch of the indicator light on the interactive interface is detected. In response to the operation for turning on the physical switch and the operation for turning off the control switch of the indicator light, a bottom layer interface is called to pop up a prompt: Built-in microphone is turned on. The bottom layer transmits a pop-up prompt parameter to the driver layer. The drive layer drives the display to display the first prompt information on the display according to the pop-up prompt parameter, and a bottom layer interface kilby.sl2.i32.avs.privacy.led.indictor.mute is called to set a value of the indicator light to 1. The bottom layer transmits a light off parameter to the drive layer according to the data 1. The drive layer controls the indicator light to change from the on state to the off state according to the light off parameter.

In an eleventh embodiment, when the control switch of the indicator light is configured to be turned off, when the on/off state of the physical switch is the on state, the indicator light to is controlled to be turned off. After displaying the first prompt information, in response to an operation command input from a user for switching the on/off state of the physical switch to the off state, the on/off state of the physical switch is controlled to be in the off state. At the same time, in response to an operation command input from a user for turning on the control switch of the indicator light, the control switch of the indicator light is controlled to be turned on. In this case, the indicator light is controlled to be turned on, and the first prompt information is controlled to be hidden on the display. In this case, the on/off state of the physical switch can be concluded to be the off state by combining the on state of the indicator light and no prompt information.

That is, when the control switch of the indicator light is turned off and the on/off state of the physical switch is the on state, the indicator light is turned off and the first prompt message is displayed. In this case, when the user wants to turn on the control switch of the indicator light and turn off the physical switch, the control switch of the indicator light can be set to be turned on on the setting interface, and then the physical switch is toggled from the ON side to the OFF side. In response to a user's operation, the indicator light is controlled to be turned on and the first prompt information is hidden.

The implementation of the eleventh embodiment can be as follows. A user's operation of setting the control switch of the indicator light to be turned on is detected, a UI layer transmits a signal indicating that the control switch of the indicator light is turned on to a underlying layer, and a user's operation for toggling the physical switch is detected, in this case, the user's operation for toggling the physical switch is turning off. In response to the operation for turning off the physical switch and the operation for turning on the control switch of the indicator light, a bottom layer interface kilby.sl2.i32.avs.privacy.led.indictor.power is called to set a value of the indicator light to 0, and the bottom layer transmits a light on parameter to the drive layer according to the data 0. The drive layer controls the indicator light to change from the off state to the on state according to the light on parameter, at the same time, the bottom layer can transmit a signal for hiding the prompt information for display to the drive layer. The drive layer hides the first prompt information on the display according to the signal for hiding and the prompt information for display.

In a twelfth embodiment, when the control switch of the indicator light is configured to be turned off, when the on/off state of the physical switch is the off state, the indicator light is controlled to be turned off. After displaying the second prompt information, in response to an operation command for turning on the physical switch from the user, the physical switch is controlled to be in the on state. At the same time, in response to an operation command for turning on the control switch of the indicator light from the user, the control switch of the indicator light is controlled to be turned on. In this case, the indicator light is controlled to keep the off state, and the second prompt information is hidden for display. The user can determine that the current on/off state of the physical switch is the on state according to the off state of the indicator light and no prompt information.

That is, when the control switch of the indicator light is turned off and the on/off state of the physical switch is the off state, when the user wants to turn on the control switch of the indicator light and turn on the physical switch, the control switch of the indicator light can be set to be turned on on the setting interface, and then the physical switch is toggled from the OFF side to the ON side. In response to the user's operation, the control indicator light is kept off and the second prompt information is hidden.

The implementation of the twelfth embodiment can be as follows. A user's operation for toggling the physical switch is detected. In this case, the user's operation for toggling the physical switch is turning on. A user's operation for turning on the control switch of the indicator light on the interactive interface is detected. In response to the operation for turning on the physical switch and the operation for turning on the control switch of the indicator light, a bottom layer interface kilby.sl2.i32.avs.privacy.led.indictor.mute is called to set a value of the indicator light to 1. The bottom layer transmits a light off parameter to the drive layer according to the data 1. The drive layer controls the indicator light to keep the off state according to the light off parameter. At the same time, the bottom layer can transmit a signal for hiding the prompt information for display to the drive layer. The drive layer hides the second prompt information on the display according to the signal for hiding the prompt information for display.

Therefore, the method for prompting an on/off state of a physical switch according to embodiments of the present disclosure can not only provide a plurality of state prompting modes, but also respectively adjust the state of the indicator light and the state of whether the prompt information is displayed based on user's adjustment of the control switch of the indicator light and the physical switch. The user can then determine on/off states of the control switch of the indicator light and the physical switch based on the state of the indicator light and the state of whether the prompt information is displayed.

In some embodiments, turning on and turning off of the control switch of the indicator light can be automatically set according to a scenario in which the display apparatus 200 is located. For example, when the scenario in which the display apparatus 200 is located is a home scenario, when an application mode of the display apparatus 200 is set as the home mode, the control switch of the indicator light can be automatically set to be off, because the user is required to face the television for a long time in the home scenario. When the on/off state of the physical switch is the off state and the indicator light remains the on state, the user is also required to face the indicator light in the on state for a long time. Therefore, in the home mode, the control switch of the indicator light is automatically set to be turned off. When the on/off state of the physical switch is the off state, the state of the physical switch is not indicated by the indicator light, instead, the on/off state of the physical switch is prompted by prompt information, the user can be prevented from facing the indicator light in the on state for a long time.

When the scenario where the display apparatus 200 is located is a shopping mall scenario, when the application mode of the display apparatus 200 is set as the shopping mall scenario, the control switch of the indicator light can be automatically set to be on, because the user does not need to face the television for a long time in the shopping mall scenario. Even if the on/off state of the physical switch is the off state, and the indicator light remains the on state, the user does not need to face the indicator light of in the on state for a long time. Therefore, the on/off state of the physical switch is indicated by the indicator light. Furthermore, compared with the method for prompting the on/off state of the physical switch by using the prompt information, the method using the indicator lighted to prompt the on/off state of the physical switch in the shopping mall scenario is simpler and more intuitive.

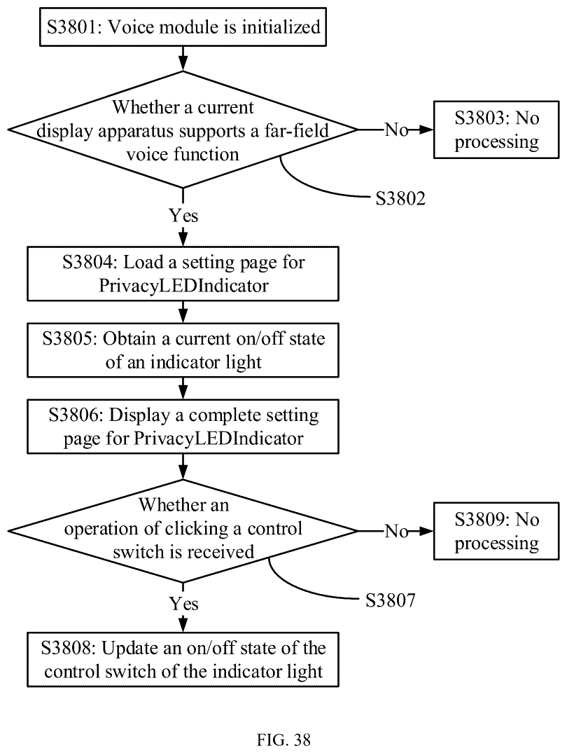

FIG. 38 shows interaction logic of on/off state update of a control switch of an indicator light. As shown in FIG. 38, after being powered on, a Voice (far-field voice) module is initialized (S3801). It is determined whether a current display apparatus supports a far-field voice function (S3802). When the far-field voice function is not supported, corresponding processing is not performed for the flow of the far-field voice function (S3803). When the far-field voice function is supported, a setting page for PrivacyLEDIndicator (the control switch of the indicator light) is loaded (S3804). After obtaining a current on/off state of the indicator light from a UI layer (S3805), a complete setting page for PrivacyLEDIndicator is displayed (S3806). When an operation of clicking a control switch input from a user is received (S3807), a message is sent to the UI layer to control update the on/off state of the control switch of the indicator light (S3808). When the operation of clicking the control switch is not received from the user, no processing is performed (S3809). The on/off state of the control switch of the indicator light is adjusted based on the interaction logic.

For the convenience of explanation, the above description has been made in combination with specific embodiments. However, the above example discussion is not intended to be exhaustive or to limit embodiments to the specific forms disclosed above. Numerous modifications and variations can be obtained in light of the above teachings. The above embodiments are chosen and described in order to better explain the principles and practical applications, to enable those skilled in the art to better utilize the described embodiments and various variant embodiments suitable for specific uses.

What is claimed is:

1. A display apparatus, comprising:
a display, configured to display an image and/or a user interface;
a communicating device, configured to establish a communication connection with a server;
at least one processor, in connection with the display and the communicating device, and configured to execute computer instructions to cause the display apparatus to:
obtain an iteration array used for representing function change information of a menu control in a menu page of a voice service;
based on that the iteration array is in a non-empty state, control the display to display a function link entry for the voice service in a preset format, wherein the function link entry is used for accessing a menu page of the voice service; the preset format is a format other than a format displayed in the menu page before a function of the menu control is changed;
determine a target change menu control according to the function change information in the iteration array;
add a preset identifier at a preset position of the target change menu control, wherein the preset identifier is used for indicating existence of change information of the target change menu control; and
control the display to display the menu page in the preset format according to the preset identifier;
wherein the at least one processor is further configured to execute computer instructions to cause the display apparatus to:
create the iteration array;
set an initial value of the iteration array as a null value;
fill the iteration array according to the function change information of the voice service.

2. The display apparatus according to claim 1, wherein the at least one processor is further configured to execute computer instructions to cause the display apparatus to:
in response to a language switch event for switching a language in the voice service, or in response to a list update event for updating a language list, after receiving a first input command, control the display to display a prompt page configured for prompting language change information in the voice service;
based on that the language list is updated and a new language is added, generate a first reminding message, and control the display to display the first reminding message on the prompt page; wherein the first reminding message is used for reminding that the new language is added to the voice service;
based on that the language list is updated and a default language locally set by the user is offline, generate a second reminding message and a third reminding message, and control the display to display the second reminding message and the third reminding message on the prompt page; wherein the second reminding message is used for reminding that the default language is offline, and the third reminding message is used for reminding a target default language currently in use.

3. The display apparatus according to claim 2, wherein the at least one processor is further configured to execute computer instructions to cause the display apparatus to:
obtain an initial language list stored locally in the display apparatus;
send a list obtaining instruction to the server, wherein the list obtaining instruction is configured to request a latest cloud language list from the server;
based on that the initial language list is inconsistent with the cloud language list, determine that the language list is updated.

4. The display apparatus according to claim 2, wherein the at least one processor is further configured to execute computer instructions to cause the display apparatus to:
control the display to display a voice interaction page after the prompt page has been displayed for a preset duration;
obtain a voice command based on the voice interaction page;
perform a function corresponding to the voice command in response to the voice command.

5. The display apparatus according to claim 1, wherein the function change information comprises first-time upgrade version information, and the at least one processor is further configured to execute computer instructions to cause the display apparatus to:
obtain initial version information of the voice service;
in response to an Over The Air, OTA, upgrade event, obtain the first-time upgrade version information of the voice service;
based on that the initial version information is different from the first-time upgrade version information, fill the iteration array according to the first-time upgrade version information.

6. The display apparatus according to claim 5, wherein the function change information comprises menu identification information, and the at least one processor is further configured to execute computer instructions to cause the display apparatus to:
obtain the menu control in the menu page:
detect a newly added menu in the menu control after the OTA upgrade event is completed;
generate the menu identification information according to the newly added menu;
fill the menu identification information into the iteration array, and control the display to display the menu page in the preset format according to the menu identification information.

7. The display apparatus according to claim 6, wherein the function change information comprises target menu control information, and the at least one processor is further configured to execute computer instructions to cause the display apparatus to:
monitor change information of a sub-menu control comprised in the menu control;
based on that a changed sub-menu control is detected, add a first label to the changed sub-menu control;
determine a target menu control corresponding to the changed sub-menu control;
add a second label to the target menu control;
fill target menu control information corresponding to the target menu control into the iteration array, and control the display to display the menu page in the preset format according to the first label and the second label.

8. The display apparatus according to claim 7, wherein the at least one processor is further configured to execute computer instructions to cause the display apparatus to:
in response to an event for accessing the function link entry from the user, delete the first-time upgrade version information in the iteration array
in response to an event for accessing the changed sub-menu control from the user, delete the target menu control information in the iteration array;
in response to an event of the user accessing the newly added menu, delete the menu identification information in the iteration array.

9. A method for a voice service in a display apparatus, comprising:
obtaining an iteration array used for representing function change information of a menu control in a menu page of the voice service;
based on that the iteration array is in a non-empty state, controlling a display in the display apparatus to display a function link entry for the voice service in a preset format, wherein the function link entry is used for accessing a menu page of the voice service; the preset format is a format other than a format displayed in the menu page before the function of the menu control is changed;
determining a target change menu control according to the function change information in the iteration array;
adding a preset identifier at a preset position of the target change menu control, wherein the preset identifier is used for indicating existence of change information of the target change menu control; and
controlling the display to display the menu page in the preset format according to the preset identifier.
